(19) United States
(12) Patent Application Publication
(10) Pub. No.: US 2002/0049670 A1
(43) Pub. Date: Apr. 25, 2002

(54) Electronic payment method and system

(75) Inventors: Toshiyuki Moritsu, Yokohama (JP); Harushi Someya, Kawasaki (JP); Ryoichi Sasaki, Fujisawa (JP); Takeshi Matsuki, Musashino (JP); Kunihito Takeuchi, Zushi (JP); Mizuhiro Sakai, Omiya (JP); Mitsuru Iwamura, Tokyo (JP)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Hitachi, Ltd., Tokyo (JP)

(21) Appl. No.: 09/803,208

(22) Filed: Mar. 9, 2001

(30) Foreign Application Priority Data
Oct. 6, 2000 (JP) 2000-313119

(51) Int. Cl. G06F 17/60

(52) U.S. Cl. 705/40

(57) ABSTRACT

An insurance agency system 1100 notifies a payment intermediary system 1200 of a payment intention. When the payment intermediary system 1200 receives a payment intention notification, it notifies a beneficiary system 1300 of the payment intention. When the beneficiary system 1300 receives the payment intention notification, it notifies the payment intermediary system 1200 of a deposit account. If the payment intermediary system 1200 receives the deposit account notification before the payment due date or during a payment period specified by the payer, the amount specified by the payer is deposited in the deposit account.

### BACKGROUND OF THE INVENTION

The present invention relates to an electronic payment method and an electronic payment system for electronically handling debt/credit relations between parties involved in a transaction.

There exists a payment method for balancing creditor/debtor relations generated by transactions where, instead of having a payment request from a recipient (a creditor with a right to receiving payment) to a payer (a debtor obligated to make payment) made at each payment, payments are made continuously based on a comprehensive contract. This payment method is used, for example, in insurance payments made by the Social Insurance Agency (the debtor) to a beneficiary (the creditor) and in payments made by an employer (the debtor) to an employee (the creditor). In the following description, the method for making payments continuously based on a comprehensive contract is referred to as “payment not requiring individual requests”. In general, payment not requiring individual requests are made by having the recipient identify a deposit account to the payer beforehand. Then, at payment time, the payer deposits funds to the deposit account.

A conventional technology relating to an electronic payment method is presented in WO96/087083(U.S. Pat. No. 5826241). In this payment method, a second Internet user providing an information product sends a payment request together with the information product to a first Internet user by way of the Internet. The first Internet user receiving the payment request pays the second Internet user using a method not involving the Internet.

The Japanese laid-open patent publication number Hei 11-353372 describes an electronic money automatic payment system. A payer device belonging to the payer (debtor) stores a payment reservation number along with payment reservation information. If a payment request indicating a payment reservation number is received from a collector device belonging to a collector (creditor), the payment request data and the payment reservation information are compared to see that they match. Then, electronic money is transferred from the payer device to the collector device.

However, in the inventions presented in WO96/087083(U.S. Pat. No. 5826241) and Japanese laid-open patent publication number Hei 11-353372, individual payment requests are made for each payment. No consideration is given to payments not requiring individual requests.

In payments not requiring individual requests, payments during a predetermined period can often continue dispersed over time. Thus, in payment methods that involve identifying deposit accounts, payment deposits may fail if the deposit account or the contact information of the recipient changes and the payer is not informed of these changes. When a deposit fails, the payer needs to investigate the reason for the failure and perform administrative operations such as contacting the recipient. This increases the burden on the payer.

A conventional technology with the object of transferring funds to a party without an account at a financial institution is presented in Japanese laid-open patent publication number Hei 11-265413. This publication describes a financial processing device which, when a transfer request is received by the sender (debtor) by way of an ATM (Automatic Teller Machine: a device for making automatic cash payments), the transfer amount is withdrawn from the sender's account. A temporary account record for the recipient or a record associated with the sender's account is generated, and the funds are stored there. When a request for payment is received from the recipient (creditor) by way of an ATM, the temporary account record or the record associated with the sender's account is read and payment is made.

In the invention in Japanese laid-open patent publication number Hei 11-265413, the transfer amount is subtracted from the sender's account when the request to send funds is made. If the transferred fund in the temporary account or the like has not been withdrawn within a valid period, the funds are paid back to the sender. In other words, in the invention in the Japanese laid-open patent publication number Hei 11-265413, the transfer funds are moved from the sender's account when the transfer request is made, rather than the transfer funds being moved from the sender's account when the payment request is made. Thus, if the transferred funds are not withdrawn, the financial processing device must perform re-paying operations, making payment operations complicated. Japanese laid-open patent publication number Hei 11-265413 simply presents a financial processing device for solving the problem of sending funds to a party without an account. No description of a payment method using this financial processing device is provided.

### SUMMARY OF THE INVENTION

The object of the present invention is to provide an electronic payment method and electronic payment system that reduces the burden on the payer resulting from a payment procedure.

The object of the present invention is to provide an electronic payment method and electronic payment system that reduces the burden on the recipient resulting from a receipt procedure.

In the present invention, a payer sends a payment intermediary a payment intention notification. If a payment intention notification is received by the payment intermediary, a payment intention notification is sent to the payment intermediary. When the recipient receives the payment intention notification, a deposit account notification is sent to the payment intermediary. The payment intermediary deposits an amount indicated by the payer in the deposit account if the deposit account notification is received by the payment intermediary within a payment period or payment due date indicated by the payer. The payer can also send the payment intention notification directly to the recipient. According to the present invention, funds are paid only if a deposit account identification is received at each payment. This prevents failed deposits if the recipient's deposit account is changed or lost. As a result, the burden resulting from payment procedures is reduced for the payer.

In another aspect of the present invention, a payer sends a payment intermediary a payment intention notification. If a payment intention notification is received by the payment intermediary, a payment intention notification is sent to the payment intermediary. When the payment intermediary receives a deposit account identification at each payment, the amount indicated by the payer is deposited in the deposit account. According to the present invention funds are paid when a deposit account identification is received within a payment period or a payment due date for each payment. This prevents failed payments if the deposit account of the recipient is changed or lost. As a result, the burden resulting from payment procedures is reduced for the payer.

In another aspect of the present invention, a deposit account identification is received beforehand from a funds recipient. Data relating to the deposit account is stored in a database. If a deposit account has been identified and a funds payment intention notification is received from a payer or a payment intermediary depositing funds to the deposit account, then the database is searched for the deposit account of the recipient identified in the payment intention. The retrieved deposit account is sent to the payer or the payment intermediary. According to the present invention, the deposit account notification is performed automatically when the payment intermediary receives a payment intention notification. This reduces the burden of funds receiving procedures for the recipient.

### BRIEF DESCRIPTION OF THE DRAWINGS

FIG. 1 is a drawing of an overall system architecture of a first embodiment of the present invention.

FIG. 2 is a drawing of the system architecture used in each system in a first embodiment of the present invention.

FIG. 3 is a drawing showing a data structure of a payment intention in a first embodiment of the present invention.

FIG. 4 is a drawing showing a data structure of deposit account identification data in a first embodiment of the present invention.

FIG. 5 is a drawing showing a data structure of a participant database in a first embodiment of the present invention.

FIG. 6 is a drawing showing a data structure of a payment intention database in a first embodiment of the present invention.

FIG. 7 is an image drawing of a login screen in a first embodiment of the present invention.

FIG. 8 is an image drawing of a payment intention input screen in a first embodiment of the present invention.

FIG. 9 is an image drawing of a deposit account identification screen in a first embodiment of the present invention.

FIG. 10 is a flowchart of a payment intention registration/notification procedure in a first embodiment of the present invention.

FIG. 11 is a flowchart of a deposit account registration procedure in a first embodiment of the present invention.

FIG. 12 is a flowchart of a periodic procedure in a first embodiment of the present invention.

FIG. 13 is a drawing showing a data structure of login data in a first embodiment of the present invention.

FIG. 14 is a drawing of the overall system architecture in a second embodiment of the present invention.

FIG. 15 is a flowchart of a periodic procedure II in a second embodiment of the present invention.

FIG. 16 is a drawing of the overall system architecture in a third embodiment of the present invention.

FIG. 17 is a drawing of a data structure in a customer database in a third embodiment of the present invention.

FIG. 18 is an image drawing of a deposit account identification screen II in a third embodiment of the present invention.

FIG. 19 is a flowchart showing a deposit account identification procedure II in a third embodiment of the present invention.

FIG. 20 is a drawing of the overall system architecture of a fourth embodiment of the present invention.

### DETAILED DESCRIPTION OF THE PREFERRED EMBODIMENTS OF THE INVENTION

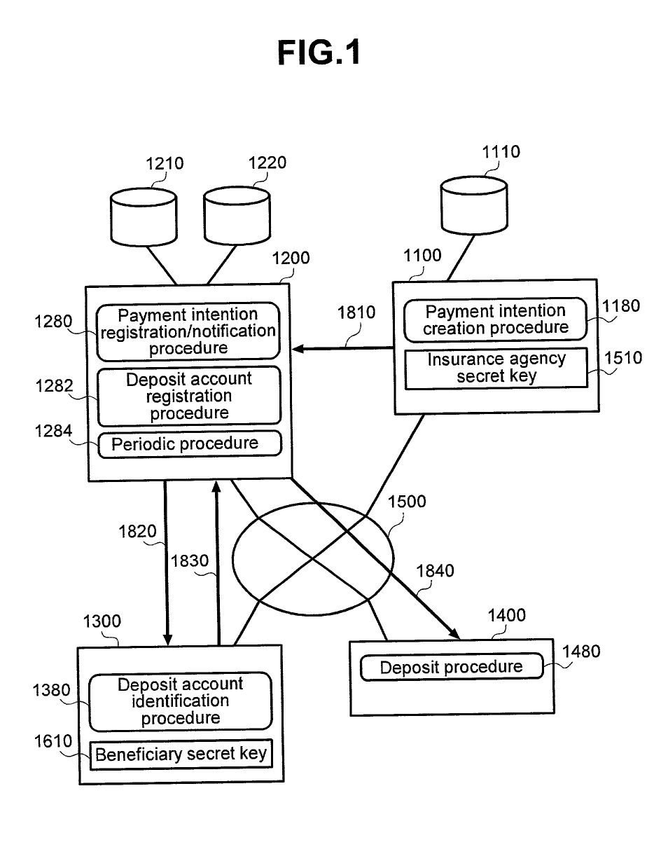

The following is a description of a first embodiment of the present invention, with references to FIG. 1 through FIG. 13.

FIG. 1 shows a drawing of an overall system architecture of a first embodiment of the present invention. The first embodiment presents an example of a payment method in which the Social Insurance Agency pays for insurance and pensions to beneficiaries.

A network 1500 connects an insurance agency system 1100 used by the Social Insurance Agency, a payment intermediary system 1200 used by a payment intermediary, a beneficiary system 1300 used by a beneficiary, and a financial system 1400 used by a financial institution. The Social Insurance Agency makes payments and is the debtor with payment responsibilities. The payment intermediary is entrusted by the Social Insurance Agency to notify beneficiaries of payment intentions and to pay monies to beneficiaries based on a receipt intention from the beneficiary (e.g., notification of deposit account information). The beneficiary is the recipient of payments and is the creditor with the right to receive monies. The financial institution is an institution that mediates financial transactions, e.g., a bank, a securities company, or a credit union. The network 1500 is a broadcast or electronic communication network, such as the Internet. The insurance agency system 1100 can be a personal computer or the like.

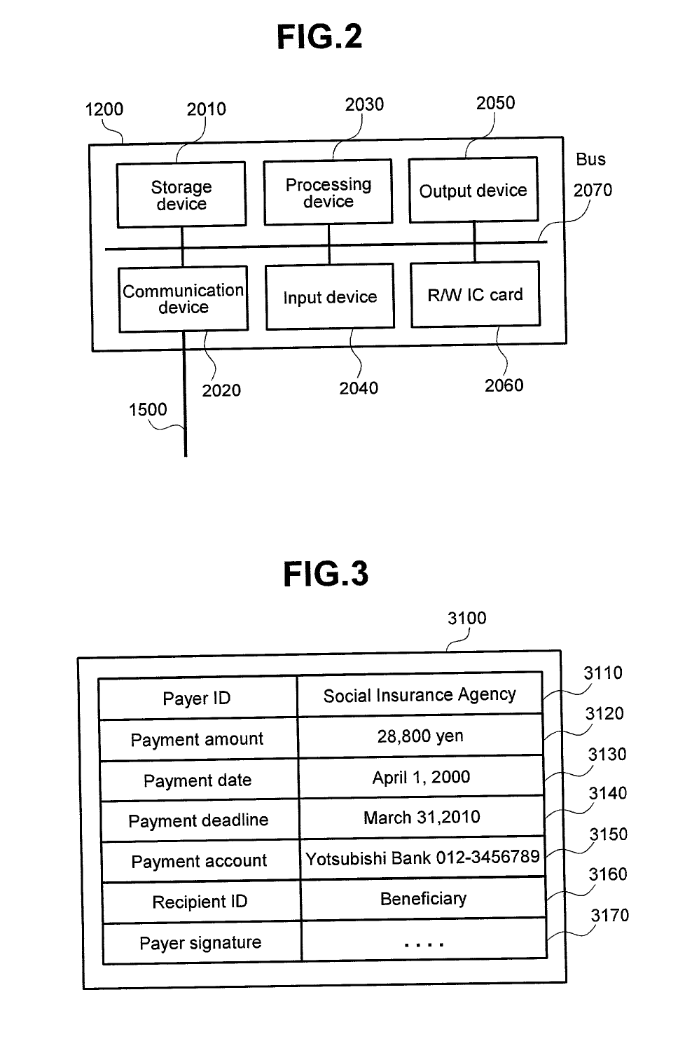

FIG. 2 shows a system architecture for the systems in the first embodiment of the present invention. In the insurance agency system, a bus 2070 connects a storage device 2010, a communication device 2020, a processing device 2030, an input device 2040, an output device 2050, and an IC card reader/writer 2060. The storage device 2010 is a device, e.g., memory, that stores data and processing programs. The communication device 2020 is a device, e.g., a network card, connected to the network 1500 that is used by the insurance agency system 1200 [?1100?] for sending and receiving data to and from the payment intermediary system 1200, the beneficiary system 1300, and the financial system 1400. The processing device 2030 is a device, e.g., a CPU, that executes program stored in the storage device 2010. The input device 2040 is a device, e.g., a keyboard and mouse, that receives external input from the user of the device or the like. The output device 2050 is a device, e.g., a display, that outputs information to the outside, e.g., for the user of the device. The IC card reader/writer 2060 is a device for sending and receiving data to and from an IC card. An IC card is a storage medium for storing data used to prove the identity of the person using the IC card.

The storage device 2010 of the insurance agency system 1100 stores a payment intention creation procedure 1180 and an insurance agency secret key 1510. As with the insurance agency system 1100 shown in FIG. 2, each of the system architectures of the payment intermediary system 1200, the beneficiary system 1300, and the financial system 1400 includes a storage device 2010, a communication device 2020, a processing device 2030, an input device 2040, an output device 2050, and an IC card reader/writer 2060 connected by a bus 2070, with the communication device 2020 being connected to the network 1500. The connection to the network 1500 can be formed as a direct connection between the communication device 2020 and the network 1500 or can be an connection formed by an intermediary connection between the communication device 2020 and the network 1500. The insurance agency system 1100 is connected to a payment intention database 1110 storing payment intentions. The intermediary connection system can be formed, for example, by an Internet connection provider system. The storage device 2010 of the payment intermediary system 1200 stores a payment intention registration/notification procedure 1280, a deposit account registration procedure 1282, and a periodic procedure 1284. The bus 2070 of the payment intermediary system 1200 is connected to a participant database 1210 and a payment intention database 1220.

The procedures stored in the storage device 2010 of the payment intermediary system 1200 can access data stored in the participant database 1210 and the payment intention database 1220. The storage device 2010 of the beneficiary system 1300 stores a deposit account identification procedure 1380 and a beneficiary secret key 1610. The storage device 2010 of the financial system 1400 stores a deposit procedure 1480. The storage device 2010 of the insurance agency system 1100 stores a deposit procedure 1480.

The following is an overview of the procedures. The payment intention creation procedure 1180 of the insurance agency system 1100 creates a payment intention 3100, shown in FIG. 3, according to a predetermined schedule (for each payment) or when an instruction to begin payment is received from personnel at the insurance agency. The procedure stores the payment intention 3100 in the payment intention database 1110 and requests the payment intention registration/notification procedure 1280 of the payment intermediary system 1200 to register the payment intention 3100. The registration message flow is provided by a payment intention registration flow 1810. The payment intention 3100 is data indicating that the party or the entrusted agent registered in the payment intention 3100 is to pay the payment amount entered in the payment intention 3110 to the recipient entered in the payment intention 3110 by the due data entered in the payment intention 3110. The payment intention registration procedure 1280 and the payment intention creation procedure 1180 can, for example, be implemented in the form of web client/server applications. For example, the payment intention registration procedure 1280 can take the form of a web server application passing data back and forth with a client application (the payment intention registration procedure 1280) by way of CGI (Common Gateway Interface). The payment intention creation procedure 1180 can be a program written in a scripting language that is executed through the browser. When the payment intention registration/notification procedure 1200 receives a request to register a payment intention 3100, it registers the payment intention 3100 in the payment intention database 1220. The payment intention registration/notification procedure 1200 also notifies the beneficiary system 1300 that the payment intention 3100 has been registered 3100. This message flow is provided by a payment intention arrival notification 1820. The insurance agency system 1100 can also notify the beneficiary system 1300 of the payment intention directly by way of the Internet 1500. The insurance agency system 1100 can register the payment intention and announce it through a web site that is accessible from the Internet 1500 and used by the social insurance agency. Also, the social insurance agency can mail the payment intention to the beneficiary. Also, the social insurance agency can register the payment intention and announce it in information media (e.g., a newspaper). The concept of “payment intention notification” includes the announcement of the payment intention. Also, the payment intention registration 1810 and the payment intention arrival notification 1820 can be sent by way of broadcast signals rather than through the network 1500.

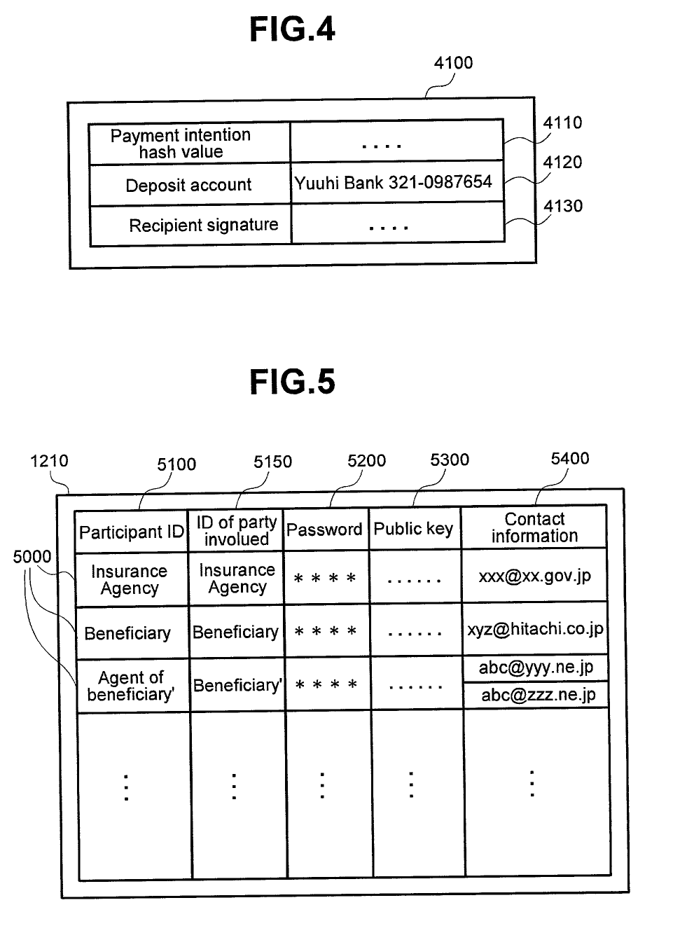

The deposit account identification procedure 1380 of the beneficiary system 1300 creates deposit account identification data 4100, shown in FIG. 4, and requests the deposit account registration procedure 1282 of the payment intermediary system 1200 to register the deposit account identification data 4100. This message flow is provided by a deposit account identification 1830. The deposit account identification data 4100 is data to instruct that payment be made to the deposit account indicated in the deposit account identification data 4100. As with the payment intention registration procedure 1280 and the payment intention creation procedure 1180, the deposit account registration procedure 1282 and the deposit account identification procedure 1380 can be implemented as web client/server applications. When the deposit account registration procedure 1282 receives a request to register deposit account identification data 4100, it registers the deposit account identification data 4100 in the payment intention database 1220.

The periodic procedure 1284 of the payment intermediary system 1200 looks up the payment intention database 1220 and extracts the payment intentions 3100 for which the deposit account identification data 4100 has been registered and for which the payment date has arrived. For these entries, the deposit procedure 1480 in the financial system 1400 is requested to make a deposit from the payment account indicated in the payment intention 3100 to the recipient account indicated in the deposit account identification data 4100. This message flow is provided by a deposit request 1840.

The deposit procedure 1480 is a procedure for paying monies to a deposit account (savings account) and includes a transfer procedure. In addition to an action performed by a financial institution, payment of monies can involve deposits made by a financial institution in response to a request from a payment intermediary, deposits made by a financial institution in response to a request from the Social Insurance Agency, deposits made by a financial institution in response to a request from a beneficiary.

The following is a detailed description of the operations performed by the different procedures.

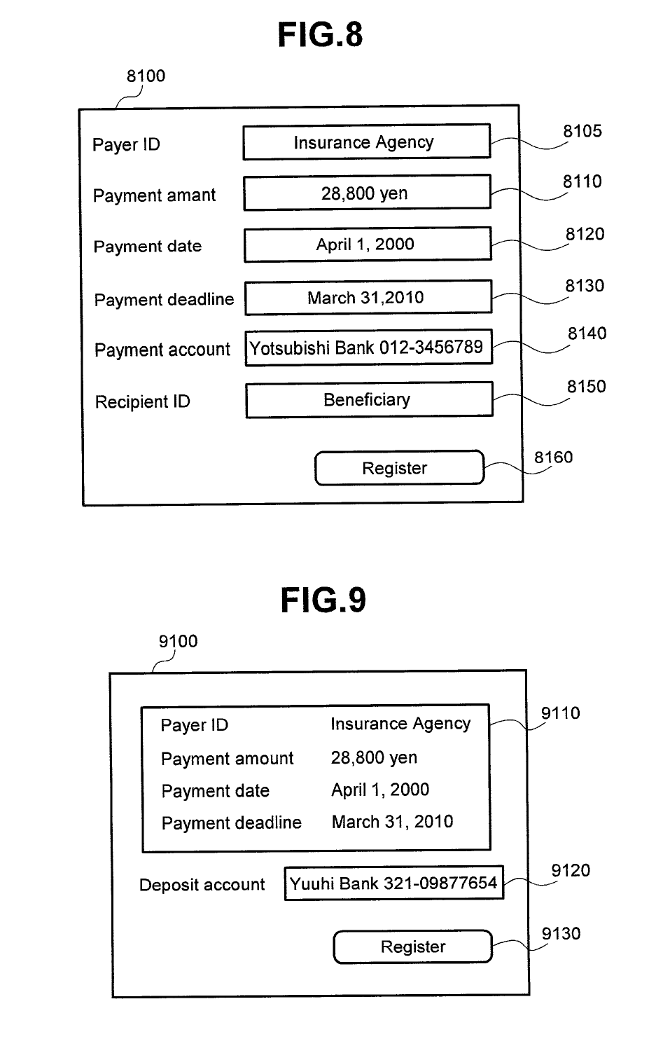

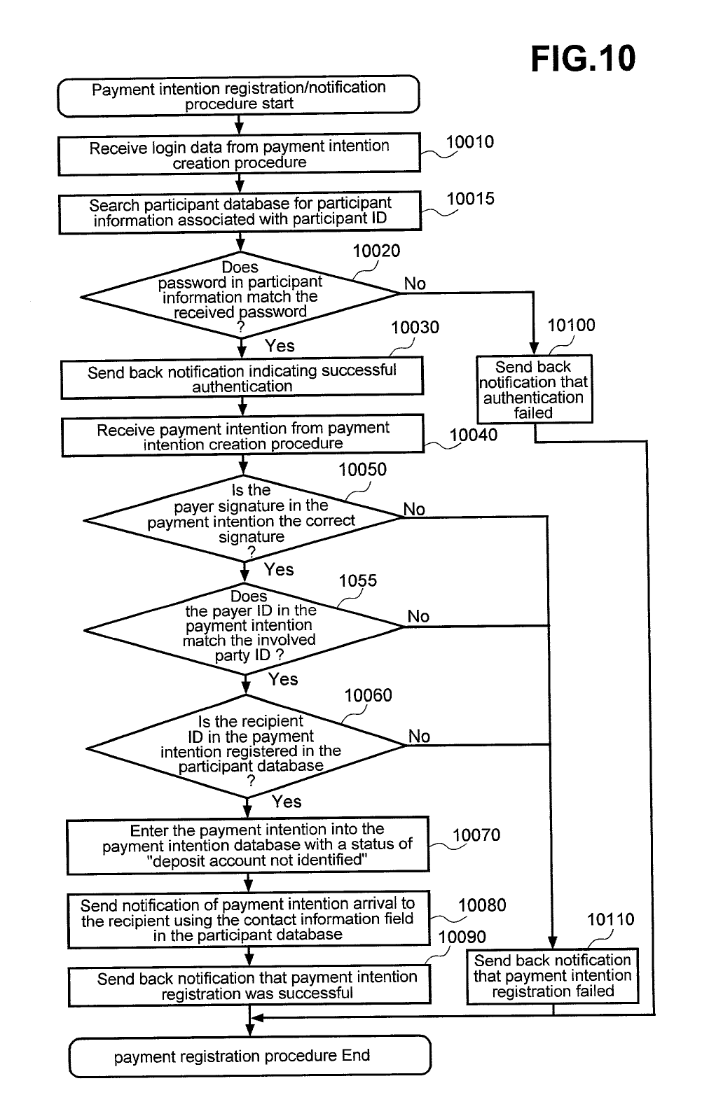

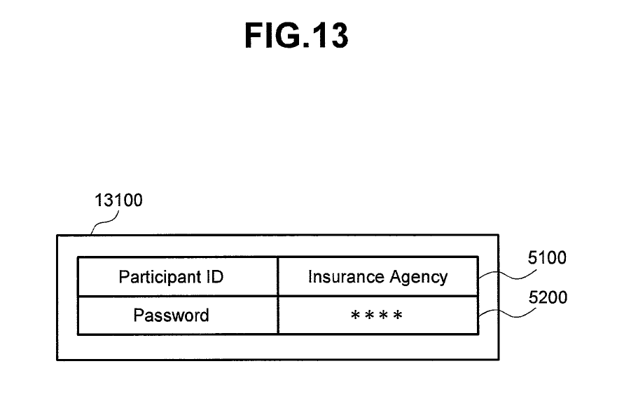

The payment intention creation procedure 1180 will be described. In the payment intention creation procedure 1180, the insurance agency system 1100 uses the output device 2050 of the insurance agency system 1100 to output a login screen 7100, shown in FIG. 7. The input device 2040 of the insurance agency system 1100 can receive entries for a participant ID entry field 7110 and a password entry field 7120. Next, the payment intention creation procedure 1180 generates login data 13100, shown in FIG. 13, when a click on a login button 7130 is detected from the input device 2040 of the insurance agency system 1100. The login data 13100 is generated by copying the values in the participant ID entry field 7110 and the password input entry field 7120 in a participant ID 5100 and a password 5200 field in the login data 13100, respectively. The payment intention creation procedure 1180 then sends the login data 13100 to the payment intermediary system 1200 (the payment intention registration/notification procedure 1280) and requests authentication. The payment intermediary system 1200 receives the sent login data 13100 at processing step 10010 of the payment intention registration/notification procedure 1280 shown in FIG. 10. The payment intermediary system 1200 sends back a response to the authentication request at processing step 10030 or processing step 10100. Authentication can be performed using a method other than a login ID/password method, such as a method using challenge data. In an authentication method using challenge data, the payment intermediary system 1200 generates a challenge data random number and sends it to the insurance agency system 1100. The insurance agency system 1100 adds a signature to the challenge data using the insurance agency secret key 1510 and sends it back to the payment intermediary system 1200. The payment intermediary system 1200 verifies the signature using a public key associated with the insurance agency secret key 1510. If the signature is verified, then authentication is considered successful. Otherwise, authentication fails. If authentication fails for the payment intention creation procedure 1180, the payment intention creation procedure 1180 is exited. If authentication is successful for the payment intention creation procedure 1180, the insurance agency system 1100 uses the output device 2050 of the insurance agency system 1100 to display a payment intention input screen 8100, shown in FIG. 8. The input device 2040 of the insurance agency system 1100 can receive input for value entries for a payer ID entry field 8105, a payment amount entry field 8110, a payment date entry field 8120, a due date entry field 8130, a payment account entry field 8140, and a recipient ID entry field 8150. When the insurance agency system 1100 receives a click to a register button 7130 from the input device 2040, the payment intention creation procedure 1180 generates the payment intention 3100, shown in FIG. 3. The payment intention 3100 is generated by copying the contents of the payer ID entry field 8105, the payment amount entry field 8110, the payment date entry field 8120, the due date entry field 8130, the payment account entry field 8140, and the recipient ID entry field 8150 to a recipient ID 3110, a payment amount 3120, a payment date 3130, a payment due date 3140, a payment account 3150, and a recipient ID 3160, respectively. The payment date 3130 is the date on which payment is started and the payment due date 3140 is the date on which payment is stopped. The payment due date 3140 may also be the period in which payment is made. The amount paid can be fixed or different amounts may be used for each payment. The payment account 3150 includes both the name of a financial institution and a deposit account. Furthermore, in the payment intention creation procedure 1180, the insurance agency system 1100 uses the insurance agency secret key 1510 to calculate signature values for the payer ID 3110, the payment amount 3120, the payment date 3130, the payment due date 3140, the payment account 3150, and the recipient ID 3160, and these signatures are stored in a payer signature 3170. The signature is generated in the same way that electronic signatures are attached to XML (Extensible Mark-up Language) documents and the like. More specifically, the contents of the payer ID 3110, the payment amount 3120, the payment date 3130, the payment due date 3140, the payment account 3150, and the recipient ID 3160 are serialized into a single string of bits. Next, a hash value is calculated for the serialized string of bits. The hash value is calculated by putting the string of bits through an irreversible one-way function (hash function) to generate a fixed-length pseudo-random number. Finally, the hash value is encrypted using the insurance agency secret key 1510. The insurance agency secret key 1510 is a secret key used for public-key encryption. The data encrypted using the secret key can be decrypted using a corresponding public key. In this specification, subsequent references to attaching signatures will be assumed to involve signatures attached using this method. Next, the insurance agency system 1100 stores the generated payment intention 3100 in the payment intention database 1110. Then, based on a predetermined schedule (at each payment) or in response to an instruction from the input device 2040 to begin payment processing, the insurance agency system 1100 calls up the payment intention 3100 from the payment intention database 1110 and outputs it to the output device 2050. Out of the payer ID entry field 8105, the payment amount entry field 8110, the payment date entry field 8120, the payment due date entry field 8130, the payment account entry field 8140, and the payer ID entry field 8150, it would be desirable for the insurance agency system 1100 to leave everything blank except for the fixed fields and outputs the results to the output device 2050. Also, in the payment intention creation procedure 1180, the insurance agency system 1100 sends the generated payment intention 3100 to the payment intention registration/notification procedure 1280 and receives a response indicating whether registration of the payment intention was successful or not. The payment intermediary system 1200 receives the sent payment intention 3100 at processing step 10040 of the payment intention registration/notification procedure 1280, shown in FIG. 10. The payment intermediary system 1200 sends a response indicating whether payment intention registration was successful or not at processing step 10090 or processing step 10110. The first embodiment presents an example where the Social Insurance Agency directly registers payment intentions 3100 in the payment intermediary system 1200, but it would also be possible for an agent representing the insurance agency to register the payment intentions 3100 of the insurance agency into the payment intermediary system 1200 in place of the Social Insurance Agency. In this case, the system architecture is identical to that of the first embodiment, but the payment intermediary system 1200 would be the agent's system.

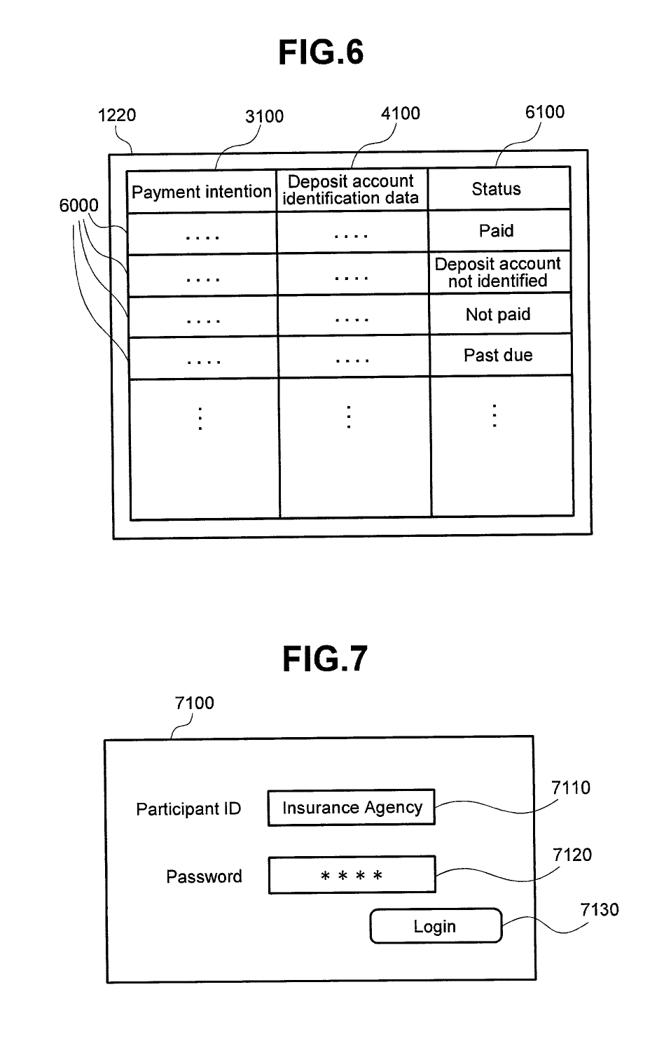

Next, the payment intention registration/notification procedure 1280 will be described. FIG. 10 shows a flowchart of the payment intention registration/notification procedure from the first embodiment of the present invention. In processing step 10010, the payment intermediary system 1200 receives the login data 13100 from the payment intention creation procedure 1180. In processing step 10015, the payment intermediary system 1200 looks up the participant database 1210 for participant information 5000 containing a participant ID 5100 that matched the participant ID 5100 from the login data 13100. The participant database 1210 is a table containing participant information 5000 entries, as shown in FIG. 5. The participant information 5000 includes the participant ID 5100, an involved party ID 5150, a password 5200, a public key 5300, and contact information 5400. The contact information 5400 can contain multiple entries. The participant ID 5100 of the participant information 5000 contains data used to determine which participant the participant information 5000 is for. A participant is a party that directly or indirectly accesses the payment intermediary system 1200 and sends and receives data. In the example shown in FIG. 5, the Social Insurance Agency, a beneficiary, and an agent of a beneficiary are registered as participants. The participant indicated by the involved party ID 5150 is the participant whose payment intention 3100 or deposit account identification data 4100 can be registered by the participant indicated in the participant information 5000. If the participant registers his/her own payment intention 3100 or deposit account identification data 4100, then the participant ID 5100 and the involved party ID 5150 will have identical values. A participant who will perform registration of payment intentions 3100 and deposit account identification data 4100 for another participant will enter his/her own participant ID in the participant ID 5100 and will enter the participant who he/she will be representing in the involved party ID 5150. The public key 5300 is the public key of the participant and contains the public key corresponding to the secret key held by the participant. The contact information 5400 contains contact information, e.g., an e-mail address, a mailing address, or a telephone number, used by the payment intermediary system 1200 to send information to the participant. In the description of operations below, a simple reference to participant information 5000 will indicate the participant information for a participant that has been looked up in a prior step in the operation. At processing step 10020, the payment intermediary system 1200 determines whether the password 5200 in the participant information 5000 matches the password 5200 from the login data 13100. If the passwords match, control proceeds to processing step 10030. Otherwise, control proceeds to processing step 10100. At processing step 10030, the payment intermediary system 1200 sends a response back to the payment intention creation procedure 1180 indicating whether or not authentication was successful. For example, the string “authentication successful” could be sent back. At processing step 10040, the payment intermediary system 1200 receives the payment intention 3100 from the payment intention creation procedure 1180. At processing step 10050, the payment intermediary system 1200 verifies the payer signature 3170 of the payment intention 3100. If the signature is verified, control proceeds to processing step 10055. Otherwise, control proceeds to processing step 10110. The verification of the payer signature 3170 is performed in the same manner as when an electronic signature on an XML document is verified. More specifically, the contents of the payer ID 3110, the payment amount 3120, the payment date 3130, the payment due date 3140, the payment account 3150, and the recipient ID 3160 are serialized into a single string of bits and a hash value for the bit string is calculated. The payer signature 3170 in the participant information 5000 is decoded using a public key, and the decoded value and the hash value are compared. If the values match, the signature is considered valid. If they do not match, the signature is considered invalid. In this specification, verification of signatures will be assumed to involve this verification method. By verifying the payer signature 3170, it can be assumed that the payer did actually create the payment intention 3100. At processing step 10055, the payment intermediary system 1200 determines whether or not the payment account 3150 in the payment intention 3100 matches the involved party ID 5150 of the participant information 5000. If they match, control proceeds to processing step 10060. Otherwise, control proceeds to processing step 10110. At processing step 10060, the payment intermediary system 1200 checks to see if there is a participant information 5000 in the participant database 1210 that has a involved party ID 5150 with the same value as the recipient ID 3160 in the payment intention 3100. If there is such an entry, control proceeds to processing step 10070. Otherwise, control proceeds to processing step 10110. In this description of the payment intention registration/notification procedure 1280, the participant information 5000 will indicate the participant information 5000 for the recipient. At processing step 10070, the payment intermediary system 1200 generates payment intention information 6000, shown in FIG. 6. The payment intention information 6000 contains the payment intention 3100, the deposit account identification data 4100, and a status 6100. The a status 6100 can, for example, be data representing the status of the payment intention 3100, where “deposit account not identified” indicates that a deposit account has not been specified, “unpaid” indicates that a deposit account has been specified but the payment date has not arrived, “paid” indicates that payment has been made, and “past due” indicates that the payment due date has passed. Furthermore, at processing step 10070, the payment intermediary system 1200 enters the payment intention 3100 received at processing step 10040 into the generated payment intention information 6000 and sets the status 6100 to “deposit account not specified”. Next, at processing step 10070, the payment intermediary system 1200 registers the generated payment intention information 6000 in the payment intention database 1220. The payment intention database 1220 is a table containing payment intention information 6000 entries, as shown in FIG. 6. At processing step 10080, the payment intermediary system 1200 sends notification that the payment intention 3100 has arrived to the contact information 5400 in the participant information 5000. If there are multiple entries in the contact information 5400, it would be desirable for notification that the payment intention 3100 has arrived to be sent to each of the entries in the contact information 5400. The notification that the payment intention 3100 has arrived can, for example, be a string such as “A payment intention has been received”. At processing step 10090, the payment intermediary system 1200 replies back to the payment intention creation procedure 1180 indicating that registration of the payment intention 3100 was successful, and the payment intention registration/notification procedure 1280 is exited. The response indicating that registration of the payment intention 3100 was successful can, for example, be a string such as “Payment intention registration successful”. At processing step 10100, the payment intermediary system 1200 sends a response back to the payment intention creation procedure 1180 indicating that authentication failed, and the payment intention registration/notification procedure 1280 is exited. The response indicating that authentication failed can, for example, be a string such as “authentication failed”. At processing step 10110, the payment intermediary system 1200 sends a response back to the payment intention creation procedure 1180 indicating that registration of the payment intention 3100 failed, and the payment intention registration/notification procedure 1280 is exited. The response indicating that registration of the payment intention 3100 failed can, for example, be a string such as “registration of payment intention failed”.

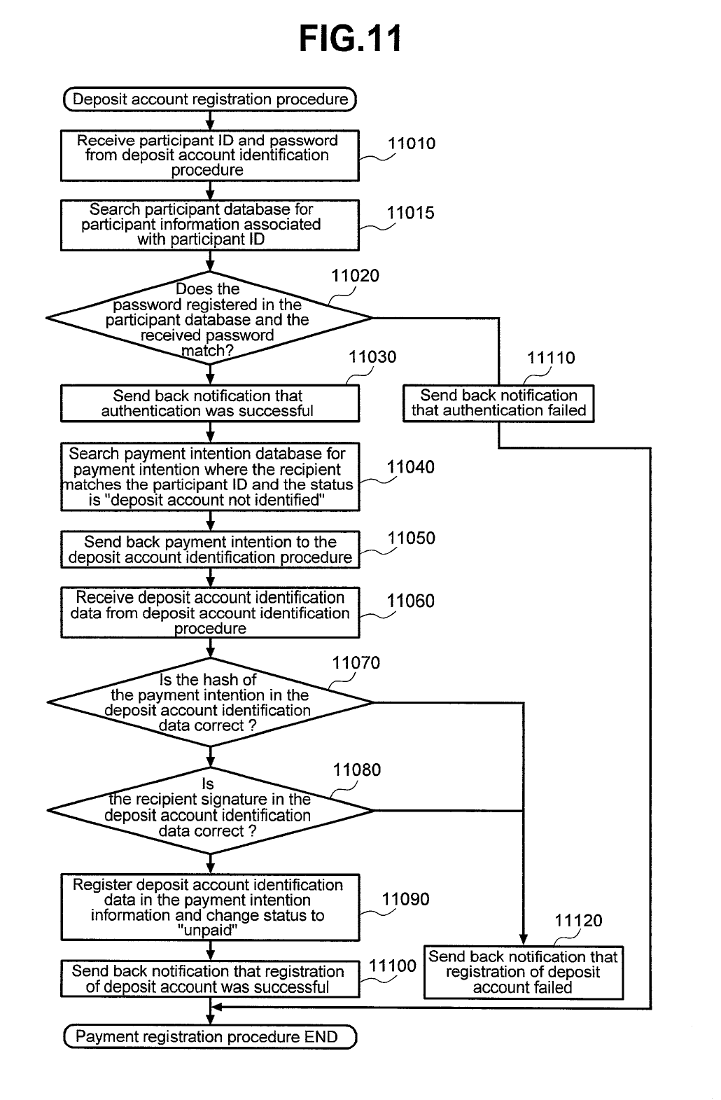

Next, the deposit account identification procedure 1380 will be described. First, the beneficiary system 1300 uses the output device 2050 of the beneficiary system 1300 is used to display the login screen 7100, shown in FIG. 7. The beneficiary system 1300 uses the input device 2040 of the beneficiary system 1300 to receive entries to the participant ID entry field 7110 and the password entry field 7120. The operations performed here are similar to the operations performed to create the login data 13100 in the payment intention creation procedure 1180. Next, the beneficiary system 1300 sends the login data 13100 to the payment intermediary system 1200 (the deposit account registration procedure 1282) and requests authentication. The payment intermediary system 1200 receives the sent login data 13100 at processing step 11010 of the deposit account registration procedure 1282, shown in FIG. 11. The beneficiary system 1300 sends a response to the authentication request at processing step 11030 or processing step 11110. If authentication fails, the beneficiary system 1300 stops the deposit account identification procedure 1380. If authentication is successful, the beneficiary system 1300 receives the payment intention 3100 from the deposit account registration procedure 1282. The payment intermediary system 1200 sends data in response to the reception of the payment intention 3100 at processing step 11050 of the deposit account registration procedure 1282. Next, the beneficiary system 1300 uses the output device 2050 of the beneficiary system 1300 to display a deposit account identification screen 9100, shown in FIG. 9. A payment intention display field 9110 displays the contents of the payment intention 3100. Next, the beneficiary system 1300 uses the input device 2040 of the beneficiary system 1300 to receive an entry for a deposit account entry field 9120. Next, when a registration button 9130 has been clicked using the input device 2040 of the beneficiary system 1300, the beneficiary system 1300 generates deposit account identification data 4100, shown in FIG. 4. In the deposit account identification data 4100, the hash value of the payment intention 3100 is calculated and stored in a payment intention hash value 4110, the contents of the deposit account entry field 9120 is copied to a deposit account 4120, and a signature for the payment intention hash value 4110 and the deposit account 4120 is calculated using the beneficiary secret key 1610 and stored in a recipient signature 4130. The payment intention hash value 4110 is data used to determine the payment intention 3100 for which a deposit account identification data 4100 indicates a deposit account 4120. This hash value is generated using the same hash calculation methods that were used in the signature generation method described above. Namely, the contents of the payment intention 3100 are serialized as a single string of bits, which is then put through an irreversible one-way function (hash function) to generate a fixed-length pseudo-random number. Next, the beneficiary system 1300 sends the deposit account identification data 4100 to the payment intermediary system 1200 (the deposit account registration procedure 1282) and receives a reply indicating whether or not registration of the deposit account was successful. This transmission is processed by processing step 11060 of the deposit account registration procedure 1282 shown in FIG. 11. The payment intermediary system 1200 responds with an indication of whether deposit account registration was successful or not at processing step 11100 or processing step 11120. This completes the deposit account identification procedure 1380 of the beneficiary system 1300.

Next, the deposit account registration procedure 1282 will be described using FIG. 11. At processing step 11010, the payment intermediary system 1200 receives the login data 13100 from the deposit account identification procedure 1380. At processing step 11015, the payment intermediary system 1200 searches the participant database 1210 for a participant information 5000 having a participant ID 5100 matching the participant ID 5100 in the login data 13100. In the following description of operations, references to the participant information 5000 will indicate the participant information retrieved in this step. At processing step 11020, the payment intermediary system 1200 determines if the password 5200 of the participant information 5000 matches the password 5200 of the login data 13100. If the passwords match, control proceeds to processing step 11030. If the passwords do not match, control proceeds to processing step 11110. At processing step 11030, the payment intermediary system 1200 sends a response to the beneficiary system 1300 (the deposit account identification procedure 1380) indicating that authentication was successful. At processing step 11040, the payment intermediary system 1200 searches the payment intention database 1220 for a payment intention information 6000 entry in which the recipient ID 3160 of the payment intention 3100 matches the involved party ID 5150 of the participant information 5000 and in which the status 6100 is “deposit account not identified”. In the following description of operations, references to the payment intention information 6000 will indicate the payment intention information 6000 retrieved at this step. At processing step 11050, the payment intermediary system 1200 sends the payment intention 3100 in the payment intention information 6000 to the beneficiary system 1300 (deposit account identification procedure 1380). At processing step 11060, the payment intermediary system 1200 receives the deposit account identification data 4100 from the beneficiary system 1300 (deposit account identification procedure 1380). At processing step 11070, the payment intermediary system 1200 checks the payment intention hash value 4110 in the deposit account identification data 4100 to see if it is valid or not. If it is valid, control proceeds to processing step 11080. Otherwise, control proceeds to processing step 11120. The verification of the payment intention hash value 4110 is performed by serializing the payment intention 3100 of the payment intention information 6000 to form a single string of bits. A hash value is calculated for the bit string, and the hash value is compared with the payment intention hash value 4110. At processing step 11080, the payment intermediary system 1200 checks to see if the recipient signature 4130 in the deposit account identification data 4100 is valid or not. If it is valid, control proceeds to processing step 11120. At processing step 11090, the payment intermediary system 1200 enters the received deposit account identification data 4100 in the deposit account identification data 4100 of the payment intention information 6000. The payment intermediary system 1200 also changes the status 6100 of the payment intention information 6000 to “unpaid”. At processing step 11100, the payment intermediary system 1200 sends a reply to the beneficiary system 1300 (deposit account identification procedure 1380) indicating that registration of the deposit account was successful, and the deposit account registration procedure 1282 is exited. At processing step 11110, the payment intermediary system 1200 sends a reply back to the beneficiary system 1300 (deposit account identification procedure 1380) indicating that authentication failed, and the deposit account registration procedure 1282 is exited. At processing step 11120, the payment intermediary system 1200 sends a reply back to the beneficiary system 1300 (deposit account identification procedure 1380) indicating that registration of the deposit account failed, and the deposit account registration procedure 1282 is exited.

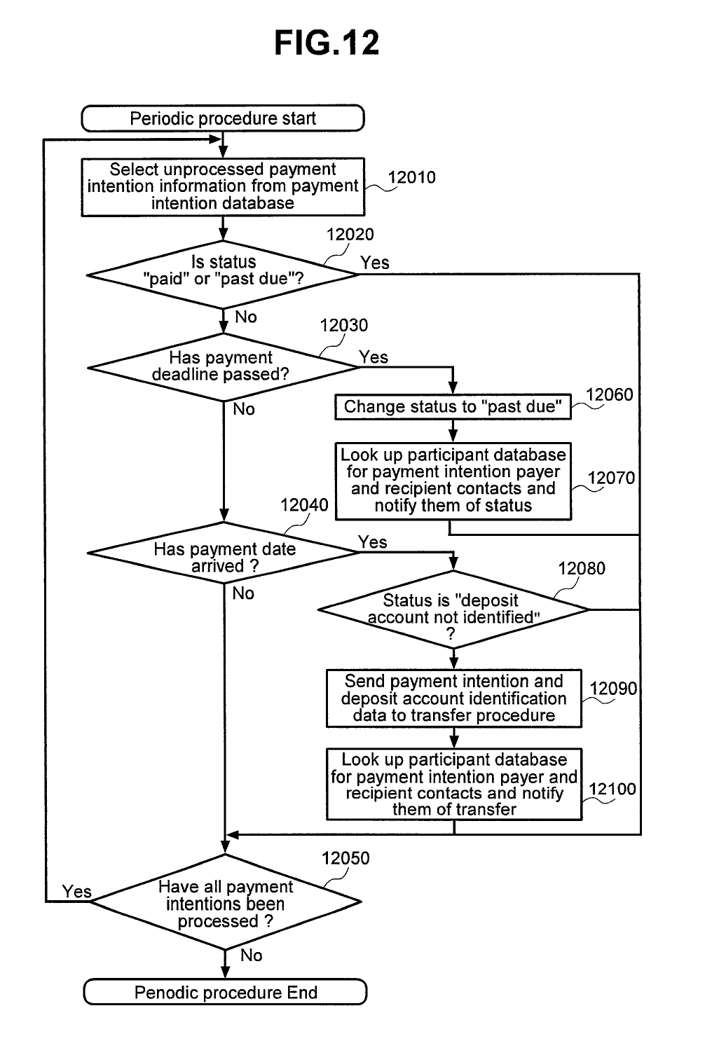

Next, the periodic procedure 1284 will be described using FIG. 12. In the processing loop formed between processing step 12010 and processing step 12050, the payment intermediary system 1200 selects an unprocessed payment intention information 6000 from the payment intention database 1220 at processing step 12010. With the exception of processing step 12050, in the following description of operations references to payment intention information 6000 will indicate the payment intention information 6000 selected at this step. At processing step 12020,p the payment intermediary system 1200 checks the status 6100 of the payment intention information 6000 to see if it is “past due” or “paid”. If it is either “past due” or “paid”, then control proceeds to processing step 12050. Otherwise (if the status is “unpaid”), control proceeds to processing step 12030. At processing step 12030, the payment intermediary system 1200 determines whether the payment due date 3140 in the payment intention 3100 of the payment intention information 6000 has passed or not. If the date has passed, control proceeds to processing step 12060. Otherwise control proceeds to processing step 12040. At processing step 12040, the processing step 1200 determines whether the payment date 3130 in the payment intention 3100 of the payment intention information 6000 has passed or not. If the date has passed, control proceeds to processing step 12080. Otherwise, control proceeds to processing step 12050. At processing step 12050, the payment intermediary system 1200 checks to see if all the payment intention information 6000 entries in the payment intention database 1220 have been processed or not. If so, the periodic procedure 1284 is exited. Otherwise control proceeds to processing step 12010. At processing step 12060, the payment intermediary system 1200 changes the status 6100 in the payment intention information 6000 to “past due”. At processing step 12070, the payment intermediary system 1200 changes the status 6100 of the payment intention information 6000 to “past due”. At processing step 12070, the payment intermediary system 1200 searches for a participant information 5000 entry with the payer ID 3110 of the payment intention 3100 in the payment intention information 6000 and an entry where the involved party ID 5150 has the same value as the recipient ID 3160. Next, the payment intermediary system 1200 sends notifications that the payment intention is past due to the contact information 5400 entries in these participant information 5000 entries. For example, a string such as “past due” and the payment intention 3100 can be sent. At processing step 12080, the payment intermediary system 1200 determines whether the status 6100 is “deposit account not identified”. If so, control proceeds to processing step 12050. Otherwise, control proceeds to processing step 12090. At processing step 12090, the payment intermediary system 1200 sends the payment intention 3100 and the deposit account identification data 4100 to the financial system 1400 (deposit procedure 1480). At processing step 12100, the payment intermediary system 1200 searches for a participant information 5000 entry with the payer ID 3110 of the payment intention 3100 in the payment intention information 6000 and an entry where the involved party ID 5150 has the same value as the recipient ID 3160. Next, the payment intermediary system 1200 sends notifications that payment has been made to the contact information 5400 entries in these participant information 5000 entries. For example, a string such as “payment made” can and the payment intention 3100 can be sent. Once processing step 1210 is completed, control proceeds to processing step 12050.

The financial institution can be either a financial institution that has the account indicated by the payment account 3150 in the payment intention 3100, i.e., an account in the name of the Social Insurance Agency, or a financial institution that has an account indicated by the deposit account 4120 of the deposit account identification data 4100, i.e., an account in the name of the beneficiary. The financial institution with the account indicated in the payment account 3150 of the payment intention 3100 and the financial institution with the account indicated by the deposit account 4120 of the deposit account identification data 4100 can be different financial institutions or can be the same. If the financial institution with the account indicated in the payment account 3150 of the payment intention 3100 and the financial institution with the account indicated by the deposit account 4120 of the deposit account identification data 4100 are the same, the financial institution will perform the transfer between accounts internally. If the financial institution with the account indicated in the payment account 3150 of the payment intention 3100 and the financial institution with the account indicated by the deposit account 4120 of the deposit account identification data 4100 are different, the deposit will take place from one financial institution to the other financial institution.

If the financial institution is the financial institution with the account indicated by the deposit account 4120 of the deposit account identification data 4100 and if the deposit account identifications 1830 are for notifications from multiple beneficiaries to the payment intermediary relating to different financial institutions, then it would be desirable for the payment intermediary to send notification of the payment intention 3100 and the deposit account identification data 4100 for each financial institution. In other words, between processing step 12080 and processing step 12090, the payment intermediary system 1200 identifies the financial institution names in the deposit account field in the deposit account identification data 4100 and organizes payment intentions 3100 and deposit account identification data 4100 by financial institution. At processing step 12090, the payment intermediary system 1200 sends a payment intention 3100 and deposit account identification data 4100 to the financial system 1400 (deposit procedure 1480) at each of the financial institutions. This reduces the number of notifications made to financial institutions via deposit requests 1840, and thus reduces the processing work required by the payment intermediary.

Next, the deposit procedure 1480 will be described. In the deposit procedure 1480, the financial system 1400 receives the payment intention 3100 and the deposit account identification data 4100 at processing step 12100 from the periodic procedure 1284 shown in FIG. 12. The amount indicated in the payment amount 3120 in the payment intention 3100 is then transferred from the account indicated by the payment account 3150 in the payment intention 3100 to the account indicated in the deposit account 4120 of the deposit account identification data 4100. The procedure is then exited. If the payment intermediary system 1200 handles the payment account 3150 and the deposit account 4120 instead of having the financial system 1400 perform the deposit procedure 1480, i.e., if the institution with the payment intermediary system 1200 is a financial institution, then the payment intermediary system 1200 can perform the deposit procedure 1480.

If there is no deposit account identification 1830 from the beneficiary system 1300 each time there is a payment obligation (each time there is a payment), then the payment intermediary system 1200 does not send a deposit request 1840 to the financial system 1400. In other words, the payment intermediary system 1200 sends a deposit request 1840 to the financial system 1400 only if a deposit account identification 1830 is received from the beneficiary system 1300 each time there is a payment obligation (each time there is a payment). Thus, even if the deposit account for a current payment is the same as the deposit account for the previous payment, the beneficiary will not be able to receive payment unless a deposit account notification is made to the payment intermediary. The payment intention registration 1810 or the payment intention arrival notification 1820 can be performed each time a payment obligation is generated (each time payment is to be made) or each multiple payment obligations are generated (each time payment is to be made).

If there is no payment intermediary (payment intermediary system 1200), the Social Insurance Agency (insurance agency system 1100) performs operations equivalent to the deposit account registration procedure 1282 and the periodic procedure 1284. Also, if there is no payment intermediary (payment intermediary system 1200), the financial institution (the financial system 1400) performs operations equivalent to the payment intention registration/notification procedure 1280, the deposit account registration procedure 1282, and the periodic procedure 1284.

When a payment intention is received from the Social Insurance Agency at each payment, the payment intermediary checks to see whether there is a beneficiary deposit account. If a beneficiary deposit account exists (if there is no change in the deposit account), payment is made to the beneficiary through a deposit to the deposit account (there may or may not be notification of arrival of the payment intention to the beneficiary). If there is no deposit account for the beneficiary (if the deposit account has changed), the beneficiary is notified of the arrival of the payment intention and is sent the payment intention. Then, payment can be deposited into a new deposit account if a new deposit account has been identified by the beneficiary. More specifically, in the deposit account registration procedure 1282, when a deposit account identification is received from the beneficiary the payment intermediary system 1200 registers the deposit account identification data 4100 in the payment intention database 1220. Next, in the payment intention registration/notification procedure 1280, when the payment intention registration 1810 is received from the insurance agency system 1100, the payment intermediary system 1200 sends the payment intention arrival notification 1820 to the beneficiary system 1300. Also, in a deposit account confirmation procedure, when the payment intermediary system 1200 receives the payment intention registration 1810 from the insurance agency system 1100, the payment intention database 1220 is searched using the beneficiary ID in the payment intention as a key to find the deposit account corresponding to the beneficiary ID. In order to check to see that the deposit account (in the beneficiary's name) exists, a confirmation request is sent to the financial system 1400 of the institution with the deposit account extracted from the search result. Also, in the deposit account confirmation procedure, when the payment intermediary system 1200 receives the payment intention registration 1810 from the insurance agency system 1100, the status 6100 of the deposit account identification data 4100 in the payment intention database is set to “deposit account not identified”. The financial system 1400 checks for the presence of the deposit account. If the deposit account exists, a response is sent to the payment intermediary system 1200 to indicate this. If the deposit account does not exist, a response is sent to the payment intermediary system 1200 to indicate this. If the holder of the deposit account has lost (closed) the deposit account or has changed deposit accounts or has transferred the title of the deposit account, the financial system 1400 assumes the deposit account does not exist. In the deposit account confirmation procedure, when a response indicating the deposit account exists is received, the payment intermediary system 1200 changes the status 6100 of the deposit account identification data 4100 in the payment intention database to “unpaid”. When the payment intermediary system 1200 receives a response indicating the deposit account exists, there is no need to send a payment intention to the beneficiary system 1300 and there is no need to receive the deposit account identification 1830 from the beneficiary system 1300. It would be desirable for the payment intention arrival notification 1820 to be sent to the beneficiary system 1300 if a response indicating that the deposit account exists is received by the payment intermediary system 1200, but it would also be acceptable to not send the payment intention arrival notification 1820 to the beneficiary system 1300. If, in the deposit account confirmation procedure, the payment intermediary system 1200 receives a response indicating that the deposit account does not exist, the steps starting with processing step 10070 from the payment intention registration/notification procedure 1280 are executed. As a result, the beneficiary need only make deposit account identification to the payment intermediary if the deposit account has changed or closed. This reduces the effort required on the part of the beneficiary in receiving payments.

The present invention can be used as a system for paying wages by setting up a firm (employer) in place of the Social Insurance Agency and workers (employees) of the firm as the beneficiaries. Also, the present invention can be used as a system for paying stock dividends by setting up a corporation in place of the Social Insurance Agency and setting up shareholders of the corporation as the beneficiaries. Also, the present invention can be used as a system for paying interest by setting up a firm issuing bonds in place of the Social Insurance Agency and setting up the bondholders as the beneficiaries.

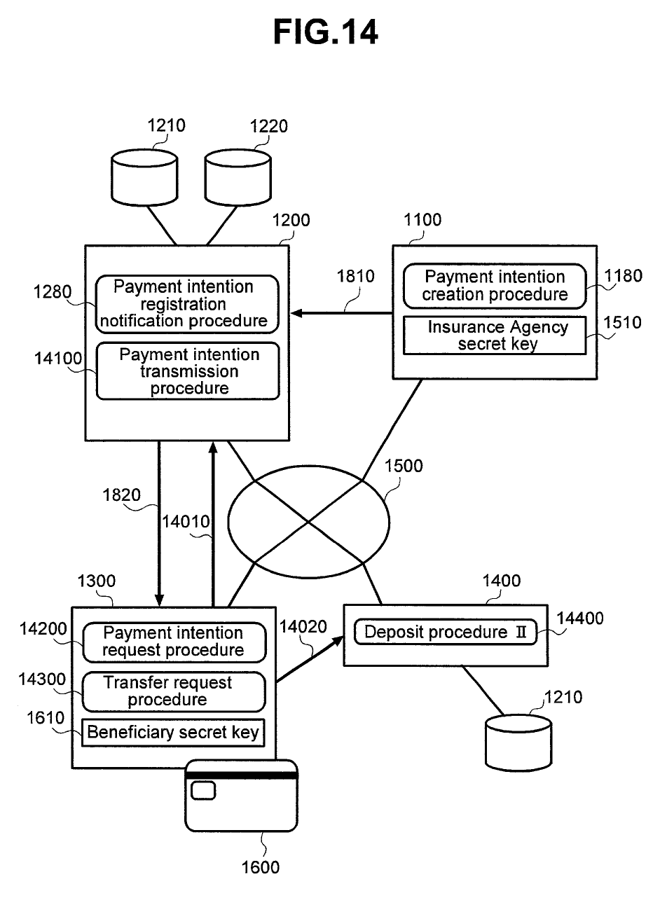

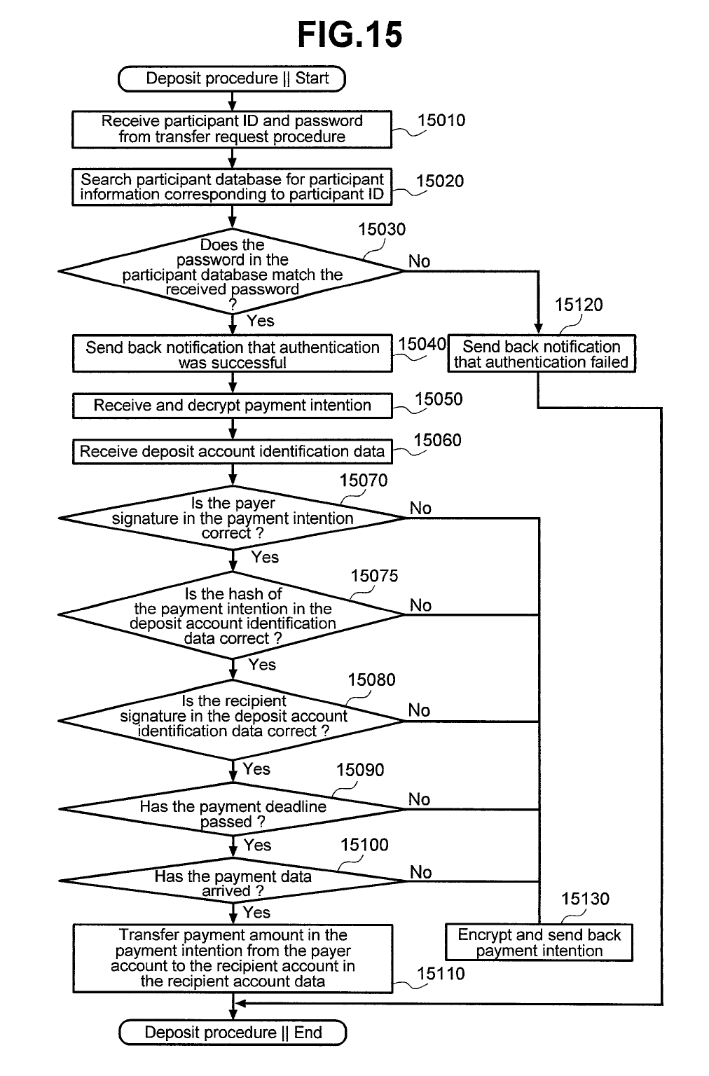

The following is a description of a second embodiment of the present invention, with references to FIG. 14 and FIG. 15.

As shown in FIG. 14, the difference between the second embodiment and the first embodiment is that instead of having the payment intermediary system 1200 make deposit requests to the financial system 1480 [?1400?], the beneficiary system 1300 makes deposit requests directly to the financial system 1480 [?1400?]. Thus, the system architecture of the second embodiment differs from the system architecture of the first embodiment in the following manner. First, the storage device 2010 of the payment intermediary system 1200 stores a payment intention request procedure 14100. The storage device 2010 of the beneficiary system 1300 stores a payment intention request procedure 14200 and a deposit request procedure 14300. A beneficiary IC card 1600 is inserted into the IC card reader/writer 2060 of the beneficiary system 1300. The storage device 2010 of the financial system 1400 stores the deposit procedure II 14400. The bus 2070 of the financial system 1400 is connected to the participant database 1210.

Next, an overview of the second embodiment will be presented using FIG. 14. The operations performed by the payment intention creation procedure 1180 and the payment intention registration/notification procedure 1280, which handles the creation, the registration, and the notification for the payment intention 3100, are the same as those from the first embodiment. In response to a request from the payment intention request procedure 14200 of the beneficiary system 1300, the payment intention request procedure 14100 sends the payment intention 3100. This message flow is provided by a payment intention download 14010 message flow. Next, the deposit request procedure 14300 creates the deposit account identification data 4100 and requests the deposit procedure II 14400 to send the payment intention 3100 and the deposit account identification data 4100. The deposit procedure II 14400 checks the contents of the payment intention 3100 and the deposit account identification data 4100 and makes the deposit.

The following is a description of the payment intention request procedure 14100, the payment intention request procedure 14200, the deposit request procedure 14300, and the deposit procedure II 14400 of the second embodiment. These operations are different from the operations of the first embodiment. The payment intention request procedure 14200 performs the same operations as the deposit account identification procedure 1380 in the first embodiment to receive authentication and receive the payment intention 3100. However, while in the deposit account identification procedure 1380 of the first embodiment requests authentication and receives the payment intention from the deposit account registration procedure 1282, the payment intention request procedure 14200 of the second embodiment requests authentication and receives the payment intention from the payment intention request procedure 14100. Also, instead of having the payment intention request procedure 14100 store the payment intention 3100 in the storage device 2010 of the beneficiary system 1300, the payment intention 3100 is encrypted and sent to the beneficiary IC card 1600. This prevents beneficiary system 1300 from creating copies of the beneficiary IC card 1600 outside of the beneficiary IC card 1600.

The payment intention request procedure 14100 performs similar operations to those of the deposit account registration procedure 1282 (up to processing step 11050 and processing step 11110) shown in FIG. 11 up to where a response to the payment intention 3100 is sent. However, the payment intention request procedure 14100 encrypts the payment intention and sends it to the beneficiary IC card 1600. Also, once the sending of the payment intention 3100 is performed, the payment intention request procedure 14100 deletes the sent payment intention 3100. This prevents the payment intermediary system 1200 from downloading the same payment intention 3100 multiple times.

Nest, the deposit request procedure 14300 will be described. The deposit request procedure 14300 performs operations similar to those of the deposit account identification procedure 1380 from when authentication is received to when the deposit account identification data 4100 is sent. The following points are different from the deposit account identification procedure 1380, however. The deposit request procedure 14300 does not download the payment intention 3100 from the deposit account registration procedure 1282. The payment intention hash value 4110 is calculated within the beneficiary IC card 1600. This prevents illegitimate copies of the payment intention 3100 from being made. Also, since the financial system 1400 verifies the payment intention, it would also be possible to have the insurance agency system 1100 or the payment intermediary system 1200 send the payment intention beforehand to the financial system 1400. Also, the deposit request procedure 14300 sends the payment intention 3100 to the deposit procedure II 14400. When this is done, the payment intention 3100 is encrypted and sent, as in the payment intention request procedure 14200. After this, the payment intention 3100 in the beneficiary IC card 1600 is deleted. This prevents the beneficiary system 1300 from making copies of the payment intention 3100 outside of the beneficiary IC card 1600. The sending of the payment intention 3100 is performed at processing step 15050 of the deposit procedure II 14400 shown in FIG. 15. Next, the deposit request procedure 14300 sends the deposit account identification data 4100 to the deposit procedure II 14400. The sending of the deposit account identification data 4100 is performed at processing step 15060 of the deposit procedure II 14400. If the deposit procedure II 14400 fails to make the deposit and sends back the payment intention 3100, the returned payment intention 3100 is stored in the beneficiary IC card 1600 as in when the payment intention 3100 is received in the payment intention request procedure 14200. This sending operation is performed at processing step 15130 of the deposit procedure II 14400. A more detailed description will be provided below.

Next, the deposit procedure 11 14400 will be described using the flowchart in FIG. 15.

The authentication operations of the deposit procedure II 14400 at processing step 15010 to processing step 15040 and processing step 15120 are similar to the authentication operations of the deposit account registration procedure 1282 at processing step 11010 to processing step 11040 and processing step 11110. However, while the deposit account registration procedure 1282 involves accessing the participant database 1210 connected to the payment intermediary system 1200, the deposit procedure II 14400 involves accessing the participant database 1210 connected to the financial system 1400. At processing step 15050, the financial system 1400 receives and decrypts the payment intention 3100. In the following description, references to payment intention 3100 will indicate this payment intention 3100 received at this processing step. At processing step 15060, the financial system 1400 receives the deposit account identification data 4100. In the following description, references to the deposit account identification data 4100 will indicate this deposit account identification data 4100 received at this processing step. At processing step 15070, the financial system 1400 checks to see if the payer signature 3170 of the payment intention 3100 is valid or not. If the signature is valid, control proceeds to processing step 15075. Otherwise, control proceeds to processing step 15130. This verification operation is performed in the same manner as the signature verification performed at processing step 10050 of the payment intention registration/notification procedure 1280. At processing step 15075, the financial system 1400 checks the payment intention hash value 4110 of the deposit account identification data 4100 to see if it is correct or not. If it is correct, control proceeds to processing step 15080. Otherwise, control proceeds to processing step 15130. This verification is performed in the same manner as the verification at processing step 11070 of the deposit account registration procedure 1282. At processing step 15080, the financial system 1400 checks to see if the recipient signature 4130 of the deposit account identification data 4100 is a valid signature or not. If so, control proceeds to processing step 15090. Otherwise, control proceeds to processing step 15130. This verification is performed in the same manner as the verification performed at processing step 11080 of the deposit account registration procedure 1282. At processing step 15090, the financial system 1400 determines whether or not the payment due date 3140 of the payment intention 3100 has passed. If so, control proceeds to processing step 15030. Otherwise, control proceeds to processing step 15100. At processing step 15100, the financial system 1400 checks to see if the payment date 3130 of the payment intention 3100 has passed or not. If so, control proceeds to processing step 15110. Otherwise, control proceeds to processing step 15030. At processing step 15110, the financial system 1400 deposits the amount indicated in the payment amount 3120 of the payment intention 3100 to the deposit account 4120 of the deposit account identification data 4100 from the payment account 3150 of the payment intention 3100. The deposit procedure II 14400 is then exited. At processing step 15130, the financial system 1400 encrypts the payment intention and sends it back to the deposit request procedure 14300 so that it can be saved to the beneficiary IC card 1600. The deposit procedure II 14400 is then exited.

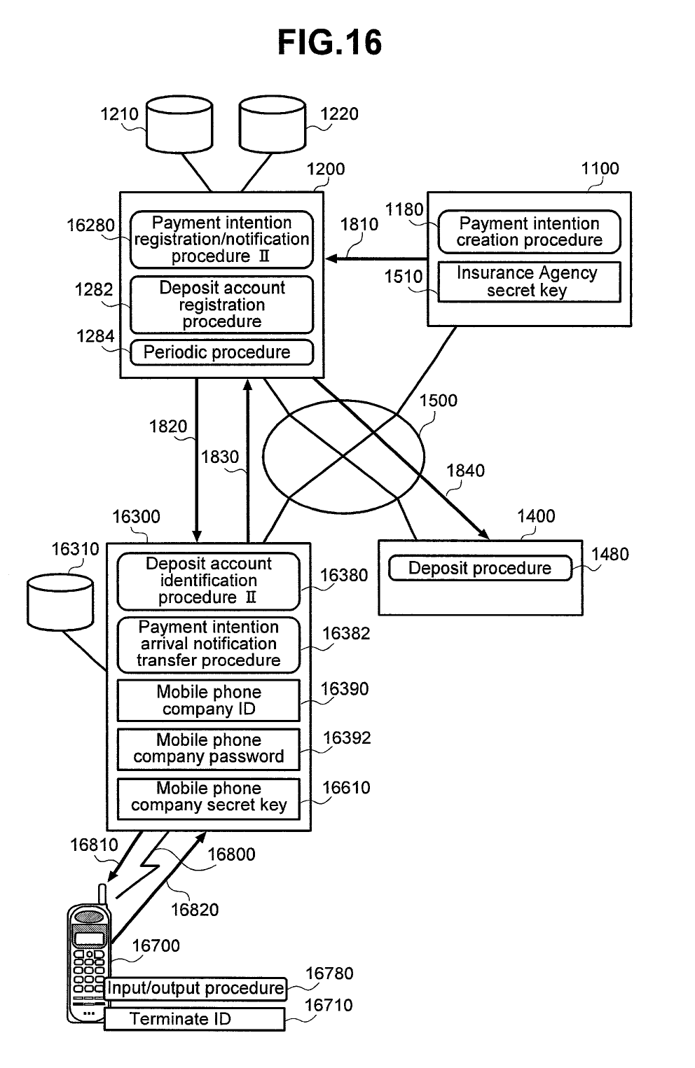

Next, a third embodiment of the present invention will be described using FIG. 16 through FIG. 19.

As shown in FIG. 16, the third embodiment differs from the first embodiment in that the beneficiary uses a beneficiary mobile terminal 16700 and connects to the payment intermediary system 1200 by way of a mobile phone company system 16300. The mobile phone company system 16300 is a network connection system connected to the network 1500.

Thus, the system architecture of the third embodiment differs from the system architecture of the first embodiment in the following manner. First, the network 1500 is connected to the mobile phone company system 16300 instead of the beneficiary system 1300. Furthermore, the mobile phone company system 16300 is connected to the beneficiary mobile terminal 16700 by way of a network 16800. The mobile phone company system 16300 is a system used by the mobile phone company and provides contracting clients with telephone network services and connection services to the network 1500. The network 16800 is a network independent from the mobile phone company system 16300 and can, for example, be a wireless telephone network. The storage device 2010 of the payment intermediary system 1200 stores a payment intention registration/notification procedure II 16280 instead of the payment intention registration/notification procedure 1280. The system architecture of the mobile phone company system 16300 includes the same devices from the system architecture of the insurance agency system 1100 shown in FIG. 2. In addition, there is a communication device used to connect to the beneficiary mobile terminal 16700 connected to the network 16800. The storage device 2010 of the mobile phone company system 16300 stores a deposit account identification procedure II 16380, a payment intention transfer procedure 16382, and a mobile phone company secret key 16610, which is the secret key of the mobile phone company. Also, the bus 2070 of the mobile phone company system 16300 is connected to a customer database 16310. Procedures executed in the mobile phone company system 16300 access the contents of the customer database 16310. The beneficiary mobile terminal 16700 has a similar system architecture to that of the payment intermediary system 1200 shown in FIG. 2, with the following exceptions. First, the third embodiment does not include a communication device 2020 connected to the network 1500. In its place, there is a communication device that connects to the network 16800. The storage device 2010 of the communication device 16710 [?] stores a terminal ID 16710 and an input/output procedure 16780. The terminal ID 16710 is used by the mobile phone company system 16300 to identify the beneficiary mobile terminal 16700.

An overview of the procedures used by the third embodiment will be described using FIG. 16. First, a request from the payment intention creation procedure 1180 of the insurance agency system 1100 is received and the payment intention registration/notification procedure II 16280 receives registration for the payment intention 3100. This message flow is provided by the payment intention registration 1810 message flow. The payment intention registration/notification procedure II 16280 notifies the payment intention transfer procedure 16382 that a payment intention has arrived. This message flow is provided by the payment intention arrival notification 1820 message flow. The payment intention transfer procedure 16382 notifies the beneficiary mobile terminal 16700 that the payment intention 3100 has arrived. This message flow is provided by a payment intention arrival notification II 16810 message flow. Next, the beneficiary mobile terminal receives an entry for the deposit account 4120 and transfers it to the deposit account identification procedure II 16380. This message flow is provided by a deposit account identification II 16820 message flow. The deposit account identification II 16820 generates the deposit account identification data 4100 and sends it to the deposit account registration procedure 1282. This message flow is provided by the deposit account identification 1830 message flow. Subsequent operations are the same as in the first embodiment. The following is a description of the payment intention registration/notification procedure II 16280, the deposit account identification procedure II 16380, and the payment intention transfer procedure 16382, which differ from the first embodiment.

The payment intention registration/notification procedure II 16280 will be described. The difference between the payment intention registration/notification procedure II 16280 and the payment intention registration/notification procedure 1280 from the first embodiment is that the payment intention registration/notification procedure II 16280 notifies the payment intention transfer procedure 16382 of the arrival of the payment intention 3100 at processing step 10080 of the payment intention registration/notification procedure 1280 shown in FIG. 10. Also, the recipient ID 3160 from the payment intention 3100 is sent along with this notification. Also, the mobile phone company system 16300 is entered for the contact information 5400 of the participant information 5000 entries in the participant database 1210 in which the involved party ID 5150 is identical to the recipient ID 3160 of the payment intention 3100.

Next, the payment intention transfer procedure 16382 will be described. When the payment intention transfer procedure 16382 receives notification from the payment intention registration/notification procedure II 16280 that the payment intention 3100 has arrived, the customer database 16310 is searched for a customer information 17000 entry in which the participant ID 5100 is the same as the received recipient ID 3160.

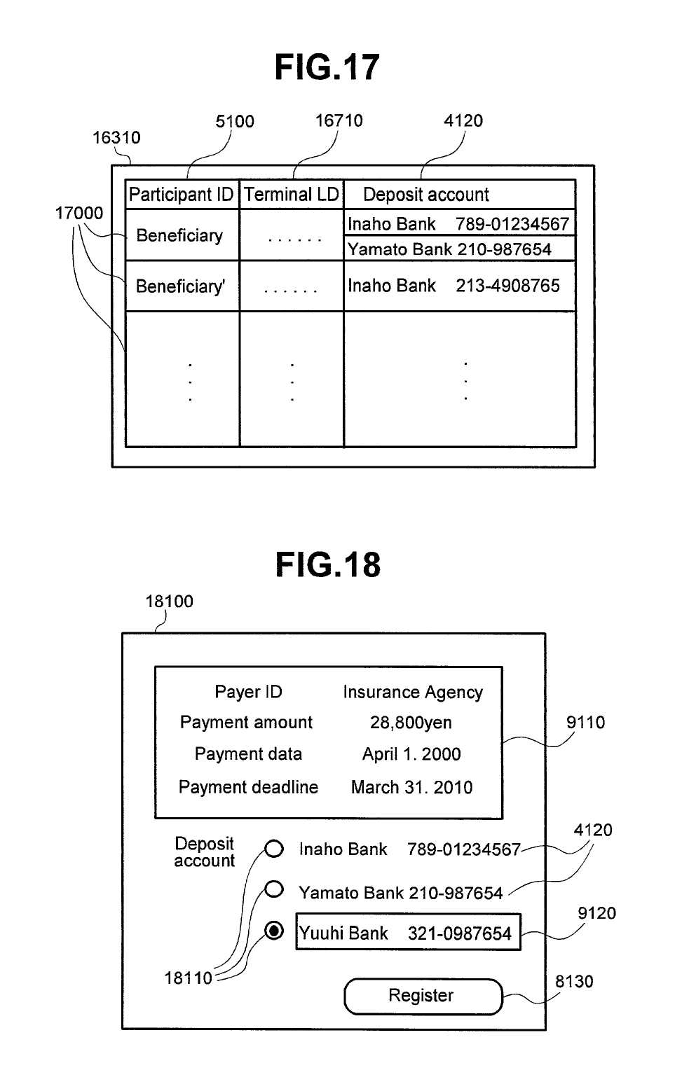

As shown in FIG. 17, the customer database 16310 is structured as a table capable of holding multiple customer information 17000 entries. The customer information 17000 includes fields for the participant ID 5100, the terminal ID 16710, and the deposit account 4120. Multiple deposit accounts 4120 can be included. The deposit account 4120 can be, for example, a deposit account identified by the beneficiary, an account used by the beneficiary for paying mobile terminal usage fees to the mobile phone company, or the like. The deposit account 4120 in the customer information 17000 is used as a list of deposit destination candidates used in an operation to identify a deposit account, described later, for the beneficiary mobile terminal 16700. The customer information 17000 contains data serving to associate the terminal ID 16710 of the recipient with the participant ID 5100 and the deposit account 4120 of the recipient. The payment intention transfer procedure 16382 sends a notification to the terminal ID 16710 of the retrieved customer information 17000 entry indicating that the received payment intention 3100 has arrived.

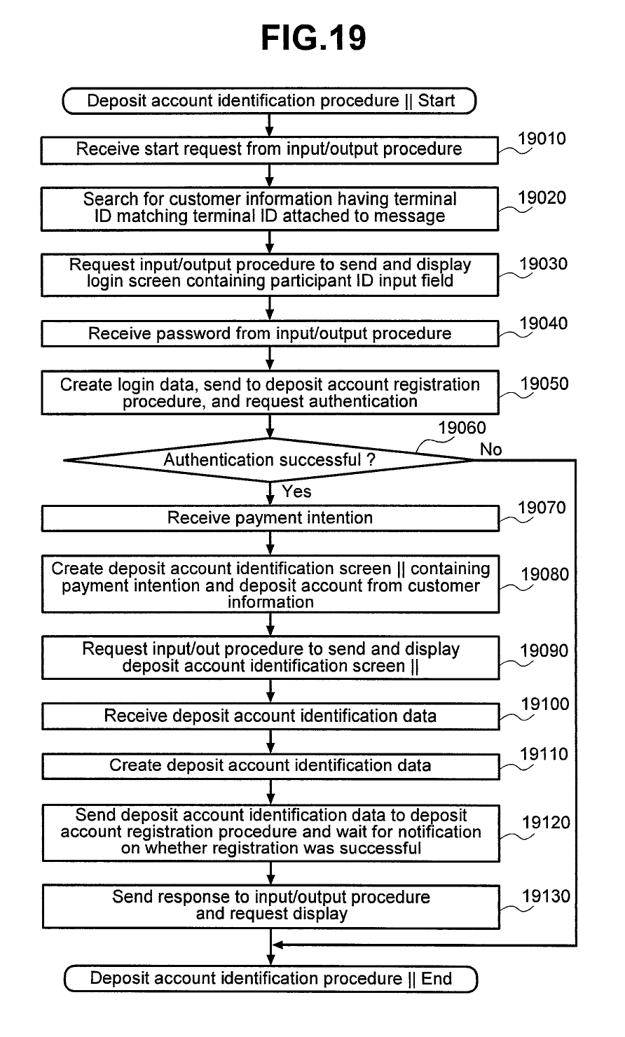

Next, the deposit account identification procedure II 16380 will be described using FIG. 19. At processing step 19010, the mobile phone company system 16300 receives a request from the input/output procedure 16780 to begin deposit account identification. At processing step 19020, the mobile phone company system 16300 searches the customer database 16310 for a customer information 17000 entry having a terminal ID 16710 that matches the terminal ID 16710 of the terminal sending the request. The terminal ID 16710 is attached to the message sent from the beneficiary mobile terminal 16700 to the deposit account identification procedure II 16380 so that the sender can be identified. In this operation, references to the customer information 17000 will indicate the customer information 17000 retrieved at this processing step. At processing step 19030, the mobile phone company system 16300 generates the login screen 7100 shown in FIG. 7 and sends it to the input/output procedure 16780 and requests that it be displayed. It would be possible to insert the participant ID 5100 of the customer information 17000 in the participant ID entry field 7110 when sending the screen. At processing step 19040, the mobile phone company system 16300 receives the password 5200 from the input/output procedure 16780. At processing step 19050, the mobile phone company system 16300 generates the login data 13100 from the participant ID 5100 from the retrieved customer information 17000 and the received password 5200. This is sent to the deposit account registration procedure 1282 and authentication is requested. The transmission of the login data 13100 by the mobile phone company system 16300 takes place at processing step 11020 of the deposit account registration procedure 1282 shown in FIG. 11. The beneficiary system 1300 responds by sending the authentication results at either processing step 11030 or processing step 1110. At processing step 19060, the mobile phone company system 16300 determines whether authentication was successful. If so, control proceeds to processing step 19070. Otherwise the deposit account identification procedure II 16380 is exited. At processing step 19070, the mobile phone company system 16300 receives the payment intention 3100 from the beneficiary system 1300 (deposit account registration procedure 1282). The mobile phone company system 16300 sends the payment intention 3100 at processing step 11050 of the deposit account registration procedure 1282 shown in FIG. 11. In the following description of this operation, references to the payment intention 3100 will indicate the payment intention 3100 received at this processing step. At processing step 19080, the mobile phone company system 16300 generates the deposit account identification screen II 18100 shown in FIG. 18. In addition to the contents of the deposit account identification screen 9100, the deposit account identification screen II 18100 includes the deposit accounts 4120 registered in the customer information 17000 and selection fields 18110 for these deposit accounts 4120 and the deposit account entry field 9120. At processing step 19090, the mobile phone company system 16300 sends the deposit account identification screen II 18100 to the input/output procedure 16780 and requests that it be displayed. At processing step 19100, the mobile phone company system 16300 receives the deposit account 4120 from the input/output procedure 16780. At processing step 19110, the mobile phone company system 16300 generates the deposit account identification data 4100. The creation of the deposit account identification data 4100 is performed in the same manner as in the deposit account identification procedure 1380. However, in this embodiment the mobile phone company adds a signature instead of the beneficiary. More specifically, the recipient signature 4130 is added using the mobile phone company secret key 16610. Also, in this embodiment, the public key of the mobile phone company is registered as a public key for the participant information 5000 entry in the participant database 1210 in which the involved party ID 5150 matches the recipient ID 3160 of the payment intention 3100. This allows the signature generated by the mobile phone company secret key 16610 to be verified when the mobile phone company system 16300 is to verify the recipient signature 4130 of the deposit account identification data 4100 in the deposit account registration procedure 1282. It would also be possible to have the beneficiary secret key 1610 stored in the mobile phone company secret key 16610, to have the deposit account identification data 4100 generated by the beneficiary mobile terminal 16700, and to have the recipient signature 4130 added using the beneficiary secret key 1610. At processing step 19120, the mobile phone company system 16300 sends the deposit account identification data 4100 to the deposit account registration procedure 1282 and receives a reply indicating whether registration was successful or not. The mobile phone company system 16300 sends a reply indicating whether registration was successful or not at processing step 11100 or processing step 11120. At processing step 19130, the mobile phone company system 16300 sends the content of the received reply to the input/output procedure 16780 and requests that it be displayed. The deposit account identification procedure II 16380 is then exited.

Next, the input/output procedure 16780 will be described. First, the beneficiary mobile terminal 16700 receives the request to begin the deposit account identification procedure by way of the input device 2040 of the beneficiary mobile terminal 16700. This is sent to a deposit account identification procedure II 15380. In the description of this operation, references to the input device 2040 and the output device 2050 will indicate the corresponding devices of the beneficiary mobile terminal 16700. The mobile phone company system 16300 receives the request to begin the deposit account identification procedure at processing step 19010 of the deposit account identification procedure II 16380. Next, the beneficiary mobile terminal 16700 receives the login screen 7100 shown in FIG. 7 from the deposit account identification procedure II 16380 and outputs it using the output device 2050. The mobile phone company system 16300 sends the login screen 7100 to the deposit account identification procedure II 16380 at processing step 19030. Next, the beneficiary mobile terminal 16700 uses the input device 2040 to receive the entry in the password entry field 7120. Next, the beneficiary mobile terminal 16700 sends the password entry field 7120 value to the deposit account identification procedure II 16380 as the password 5200. The mobile phone company system 16300 receives the sent password 5200 at processing step 19019040 [?19040?]. Next, the beneficiary mobile terminal 16700 receives the deposit account identification screen II 18100 from the mobile phone company system 16300 (the deposit account identification procedure II 16380) and displays it using the output device 2050. In the mobile phone company system 16300, the deposit account identification screen II 18100 is sent by the deposit account identification procedure II 16380 at processing step 19090 of the deposit account identification procedure II 16380. Next, the beneficiary mobile terminal 16700 uses the input device 2040 to receive a selection for one of the selection fields 18110. If the selection field 18110 corresponding to the deposit account 4120 is selected, the beneficiary mobile terminal 16700 sends back the deposit account 4120 corresponding to the selected selection field 18110 to the deposit account identification screen II 18100 of the deposit account identification procedure II 16380. If the selection field 18110 corresponding to the deposit account entry field 9120 is selected, the beneficiary mobile terminal 16700 uses the input device 2040 to receive an entry for the deposit account entry field 9120 and the contents of the deposit account entry field 9120 are sent back to the deposit account identification screen II 18100 of the deposit account identification procedure II 16380 as the deposit account 4120. The mobile phone company system 16300 receives the reply to the deposit account identification screen II 18100 at processing step 19100 of the deposit account identification screen II 18100. Next, the beneficiary mobile terminal 16700 receives notification from the deposit account identification screen II 18100 of the mobile phone company system 16300 on whether registration was successful or not. The output device 2050 is used to provide output, and the input/output procedure 16780 is then exited. The mobile phone company system 16300 sends information on whether registration was successful or not at processing step 19130 of the deposit account identification screen II 18100.

In the example presented in the third embodiment, deposit accounts can be identified using bi-directional TV by having a bi-directional TV information provider system be the deposit account identification procedure II 16380 and by having a bi-directional TV or operation terminal (e.g., a remote control) be the beneficiary mobile terminal 16700. In the example presented in the third embodiment, the deposit account can be identified using the Internet by having an Internet service provider be the deposit account identification procedure II 16380 and by having an Internet connection terminal (e.g., a personal computer) be the beneficiary mobile terminal 16700.

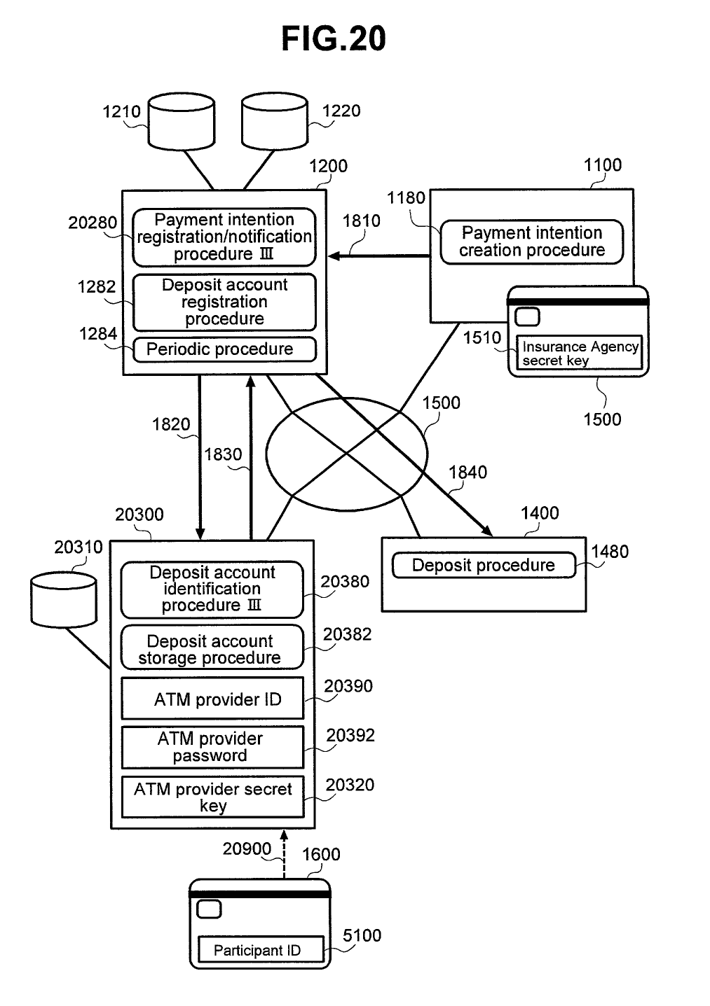

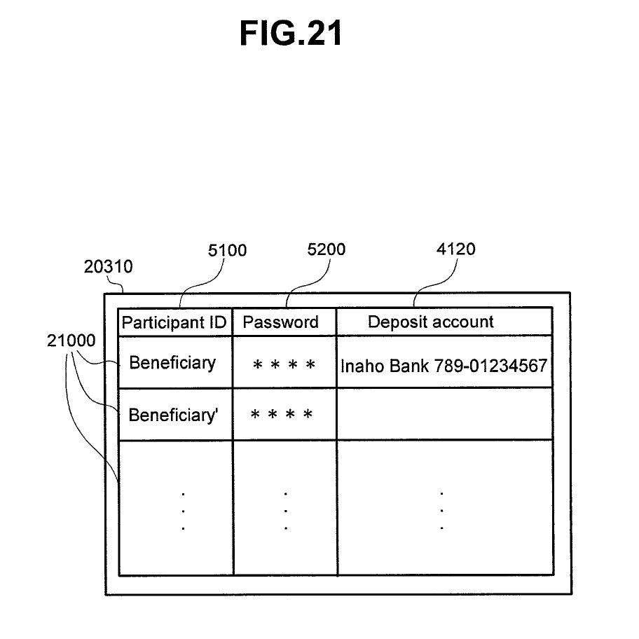

Next, a fourth embodiment of the present invention will be described using FIG. 20 and FIG. 21.

The system architecture of the fourth embodiment differs from the system architecture of the first embodiment in the following ways. First, an ATM provider system 20300 is connected to the network 1500 in place of the beneficiary system 1300. The ATM provider system 20300 is the system of a financial firm or the like providing ATMs. Instead of the payment intention registration/notification procedure 1280, the payment intermediary system 1200 includes a payment intention registration/notification procedure III 20280. The system architecture of the ATM provider system 20300 is the same as the system architecture of the insurance agency system 1100 shown in FIG. 2. Generally, ATM providers are considered to have geographically dispersed ATM terminals and a center that centralizes the input from these multiple ATM terminals. However, this embodiment presents a simplified ATM provider system 20300 where the functions of an ATM terminal and a center are combined into a single unit. Thus, it is also possible to implement the fourth embodiment can be implemented in systems where the ATM terminal and the center are physically distant from each other. A customer database II 20310 is connected to the bus 2070 of the ATM provider system 20300. The contents of the customer database II 20310 can be accessed from procedures stored in the storage device 2010 of the ATM provider system 20300. The storage device 2010 of the ATM provider system 20300 contains a deposit account identification procedure III 20380, a deposit account storage procedure 20382, an ATM provider ID 20390, an ATM provider password 20392, and an ATM provider secret key 20320.

Next, an overview of the operations performed by the fourth embodiment will be described using FIG. 20. First, in the ATM provider system 20300, a beneficiary inserts the beneficiary IC card 1600 into the IC card reader/writer 2060. When insertion of the beneficiary IC card 1600 is detected, the ATM provider system 20300 activates the deposit account storage procedure 20382, authenticates the beneficiary, receives an entry for the deposit account 4120, and saves it to the customer database II 20310. The payment intention creation procedure 1180 of the insurance agency system 1100 registers the payment intention 3100 in the payment intention registration/notification procedure II 16280 of the payment intermediary system 1200. This message flow is provided by the payment intention registration 1810 message flow. Next, the deposit account identification procedure III 20380 notifies the deposit account identification procedure III 20380 that a payment intention has arrived. This message flow is provided by the payment intention arrival notification 1820 message flow. The deposit account identification procedure III 20380 receives this arrival notification and generates deposit account identification data from the deposit account 4120 stored in the customer database II 20310. This is sent to the deposit account registration procedure 1282. This message flow is provided by the deposit account identification 1800 message flow. Subsequent operations are similar to those of the first embodiment. The following is a description of differences between this embodiment and the first embodiment.

The deposit account storage procedure 20382 will be described. First, the ATM provider system 20300 reads the participant ID 5100 off of the beneficiary IC card. Next, the ATM provider system 20300 receives an entry for the password 5200 using the input device 2040. Next, the ATM provider system 20300 searches the customer database II 20310 for a customer information II 21000 entry having the same participant ID 5100. The customer database II 20310 is formed as a table capable of holding multiple entries of customer information II 21000. The customer information II 21000 includes fields for the participant ID 5100, the password 5200, and the deposit account 4120. In the description of this operation below, references to the customer information II 21000 will indicate the customer information II 21000 entry retrieved here. Next, the ATM provider system 20300 checks to see if the entered password 5200 matches the password 5200 of the customer information II 21000. If there is no match, the deposit account storage procedure 20382 of the ATM provider system 20300 is exited. Next, using the input device 2040, the ATM provider system 20300 receives an entry for the deposit account 4120. Finally, the ATM provider system 20300 stores the entered deposit account 4120 into as the deposit account 4120 in the customer information II 21000, and the deposit account storage procedure 20382 is exited.

Next, the payment intention registration/notification procedure III 20280 will be described. The difference between the payment intention registration/notification procedure III 20280 and the payment intention registration/notification procedure 1280 is that in payment intention registration/notification procedure III 20280, the deposit account identification procedure III 20380 is the destination for the notification sent at processing step 10080 of the payment intention registration/notification procedure 1280 shown in FIG. 10 indicating the arrival of the payment intention 3100. Also, the recipient ID 3160 in the payment intention 3100 is sent along with the notification of the arrival of the payment intention 3100. Also, the ATM provider system 20300 is included in the contact information 5400 of the participant information 5000 having the involved party ID 5150 matching the recipient ID 3160 of the payment intention 3100.

Next, the deposit account identification procedure III 20380 will be described. First, the ATM provider system 20300 receives the notification of the arrival of the payment intention and the recipient ID 3160 from the payment intention registration/notification procedure III 20280. Next, the ATM provider system 20300 searches the customer database II 20310 for a customer information II 21000 entry with a participant ID 5100 matching the recipient ID 3160. In the following description of operations, references to customer information II 21000 will indicate this retrieved customer information II 21000 entry. Next, the ATM provider system 20300 generates the login data 13100 from the ATM provider ID 20390 and the ATM provider password 20392 and sends it to the deposit account registration procedure 1282 to request authentication. The operations in the deposit account identification procedure III 20380 up to the receipt of the payment intention 3100 are the same as those of the deposit account identification procedure 1380. Next, the ATM provider system 20300 generates the deposit account identification data 4100. The deposit account identification data 4100 is generated by calculating the hash value of the received payment intention 3100 and using it as the payment intention hash value 4110 and using the deposit account 4120 of the customer information II 21000 as the deposit account 4120 of the deposit account identification data 4100. The ATM provider secret key 20320 is used to add the recipient signature 4130. The details of the method used to generate the deposit account identification data 4100 are similar to those from the first embodiment. As with the third embodiment, the ATM provider adds its signature in place of the beneficiary in the fourth embodiment. Thus, in the participant information 5000 from the participant database 1210 having an involved party ID 5150 that matches the recipient ID 3160 of the payment intention 3100, a public key corresponding to the ATM provider secret key 20320 is entered in the public key 5300. Next, the ATM provider system 20300 sends the generated deposit account identification data 4100 to the deposit account registration procedure 1282 and receives a reply indicating whether registration was successful or not. Deposit account identification procedure III 20380 is then exited.

In the fourth embodiment, the beneficiary can register a deposit account in the ATM provider system 20300 so that the deposit account identification 1830 can be sent to the payment intermediary system 1200 automatically if the ATM provider system 20300 receives the deposit account identification 1830 message flow. Thus, the need for the beneficiary to send the deposit account identification 1830 to the payment intermediary system 1200 at each payment is eliminated. Thus, the ATM provider can be referred to as an intermediary entrusted by the beneficiary to mediate payments, i.e., a payment intermediary.

In the first embodiment through the fourth embodiment, it would be desirable to provide “payments without requiring individual requests” (i.e., a continuous payment method based on comprehensive contract). The payer enters into a contract with the recipient agreeing to pay monies periodically or irregularly to the recipient. Then, before the payment date, the payer then directly or indirectly, through a payment intention notifier, notifies the recipient of payment intention. Payment is made only to recipients who have identified deposit accounts to the payment intention notifier. The payer makes payment to the recipient by way of the payment intention notifier. It would also be possible for products or services to be provided in place of payment. If there is no contract, it is possible to have an oral or implied contract between the payer and the recipient.

The contents of the comprehensive contract can be, for example, “the payer will pay an amount to the recipient at the first of each month”, “the payer will pay an amount to the recipient during the period of April 1 through July 31”, and the like. Furthermore, the following can be added to the comprehensive contract: “payment will be made if a deposit account notification is made within five days from the payment date”, “the payer is considered to have fulfilled the payment obligation when the recipient is notified of a payment intention”, “the payer is considered to have fulfilled the payment obligation when the payer has notified a payment intermediary of a payment intention”, and the like.

In the first embodiment through the fourth embodiment of the present invention, a new payment model is implemented using computers, the Internet, and the like. The first embodiment through the fourth embodiment of the present invention provides a place (the payment intermediary system 1200) for posting payment intention, which is data indicating that the payer has the intention of making payment to a recipient. The payer then registers the place of the payment intention (the payment intermediary system 1200) to fulfill the payment obligation. Then, the recipient accesses the payment intermediary system and receives the payment. In this payment model, the payer must be made aware of failed deposits caused by changes in the recipient account. The payment intentions referred to here are similar to electronic checks in the sense that both contain data. However, electronic checks are used differently and are excluded from the payment intentions referred to in the first embodiment through the fourth embodiment of the present invention. Also, it is possible that this payment model can be used to shift administrative costs of the payer onto the recipient. However, when a payment fails, there is generally a greater demand to complete the payment on the part of the recipient of the payment rather than the payer. Also, the beneficiary should bear the risks and costs involved in failed payments caused by changes in the recipient's deposit account or contact information. The responsibilities assigned to the payer and the recipient in this payment model are based on these considerations. As a result, the payer does not need to track down the recipient if the recipient could not receive payment due to issues involving the recipient.

Thus, the first embodiment through the fourth embodiment of the present invention provides a payment model in which the creditors, who generally have a greater need for the payment to be completed and who determine the method used to make payments, assumes the risks and costs involved in payment failures instead of the debtor.

With the first embodiment through the fourth embodiment of the present invention, the payment intermediary system does not transfer or deposit funds unless it receives deposit account identification from the beneficiary each time there is to be a payment. Thus, the burden involved in making repayments when the beneficiary does not come to receive payment is reduced.

The programs that are used to execute the different procedures in the systems of the first embodiment through the fourth embodiment of the present invention can be stored in recording media (e.g., floppy disks, hard disks, memory cards, memory sticks, MOs, PDs, CD-ROMs, CD-R/RWs, DVD-ROMs, DVD-RAMs, servers). It would also be possible to have a server storing the programs containing the procedures to be executed on different systems distribute the programs to the systems executing these procedures by way of the Internet.

What is claimed is:

1. A method for mediating an electronic payment by sending and receiving electronic data, comprising:
sending electronic data relating to a payment intention to a recipient system belonging to a recipient of funds when electronic data relating to a funds payment intention is received from a payer system belonging to a payer of funds, and
transferring funds from assets held by the payer to an identified account when electronic data relating to a deposit account is received from the recipient system each time there is a payment obligation within a payment due date or a payment period determined by the electronic data relating to the payment intention.

2. A method for mediating an electronic payment using a computer, comprising:
sending a payment intention to a recipient identified by a payer when a notification of the payment intention from the payer of funds is received, and
depositing funds as indicated by the payer into a deposit account when a deposit account identification is received from the receiver for each payment.

3. A method for mediating an electronic payment using a network or broadcast signals wherein:
when electronic data relating to a fund payment intention is received from a payer of funds, the electronic data relating to the payment intention is sent to a recipient indicated by the payer of funds, and
when a deposit account identification is received from the recipient within a payment due date or a payment period indicated by the payer, the payment intention is sent by way of a network or broadcast signals each time there is a payment obligation, the payment intention being sent to a payment intermediary depositing funds to the deposit account.

4. A method for mediating an electronic payment using a computer, comprising:
making a fund payment intention notification to a fund recipient or a payment intermediary, and
depositing funds directly to a deposit account or indirectly by way of the payment intermediary when, at each payment, a deposit account identification from the recipient is received directly or indirectly by way of the payment intermediary.

5. A method for mediating an electronic payment using a computer wherein:
at each payment, electronic data relating to a payment intention for validating legitimacy of a recipient when receiving funds is sent directly to the recipient of funds or indirectly by way of a payment intermediary, and
when, during a specified payment period or payment due date, a deposit account identification from the recipient is received directly or received by the payment intermediary or received by a financial institution, funds are deposited in the deposit account.

6. A method for mediating an electronic payment using a network or broadcast signals wherein:
when a funds payment intention is received by a funds payer, electronic data relating to the payment intention is received by way of a network or broadcast signals from a payment intermediary sending, who sends the payment intention to a funds recipient, and
when electronic data relating to a deposit account is sent to the payment intermediary or a financial institution by way of a network, funds are deposited in the deposit account even when the deposit account notified for a current payment is identical to a deposit account notified for a past payment.

7. A system for mediating an electronic payment using a computer, comprising:
a payment intention registration/notification processing module receiving electronic data relating to a funds payment intention from a payer system belonging to a funds payer,
a deposit account registration processing module sending electronic data relating to the payment intention to a recipient system belonging to a funds recipient and receiving electronic data relating to a deposit account identification from the recipient system, and
a periodic processing module determining electronic data relating to the deposit account identification received within a payment period or a payment due date indicated in the electronic data relating to the payment intention, and transferring funds from the assets held by the payer to the determined deposit account.

8. The system of claim 7 comprising a deposit account confirmation processing module receiving electronic data relating to the deposit account identification and sending to a financial institution system belonging to a financial institution electronic data used to check for the existence of a recipient deposit account determined from the electronic data relating to the deposit account identification.

9. The system of claim 8 wherein the periodic processing module receives electronic data from the financial institution system indicating existence of the deposit accounts and begins processing.

10. The system of claim 7 wherein the electronic data relating to the payment intention includes at least one of a payment amount, a payment date, a payment due date, a payment period, a payer ID identifying a payer, and a recipient ID identifying a recipient.

11. The system of claim 10 wherein the electronic data relating to the payment intention includes a payer signature, in which a payer secret key is used to encrypt a hash value of a bit string of at least one of a payment amount, a payment date, a payment due date, a payment period, a payer ID identifying a payer, and a recipient ID identifying a recipient.

12. The system of claim 11 wherein the deposit account registration processing module calculates a hash value of a bit string of at least one of a payment amount, a payment date, a payment due date, a payment period, a payer ID identifying a payer, and a recipient ID identifying a recipient, decrypts the payer signature using a public key, and checks to see whether the hash value and the decrypted payer signature match.

13. The system of claim 7 wherein the electronic data relating to the deposit account identification includes a hash value of electronic data relating to the payment intention.

14. The system of claim 13 wherein:
the payment intention registration/notification processing module registers electronic data relating to the payment intention in the payment intention database, and
the deposit account registration processing module compares a hash value of electronic data relating to the payment intention registered in the payment intention database with a hash value of the payment intention contained in the electronic data relating to the deposit account identification.

15. The system of claim 13 wherein the electronic data relating to the deposit account identification includes a recipient signature generated by using a public key to encrypt a hash value of the payment intention and a signature associated with the deposit account.

16. The system of claim 15 wherein the deposit account registration processing module uses a public key to decrypt the recipient signature and checks to see if the decrypted recipient signature matches a payment intention hash value and a signature value associated with the deposit account contained in electronic data relating to the deposit account identification.

17. The system of claim 7 wherein the periodic processing module requests a financial system managed or owned by a financial institution to deposit funds from assets held by the payer into the deposit account.

18. The system of claim 7 wherein the payment intention registration/notification processing module sends notification to the recipient system indicating arrival of the payment intention.

19. The system of claim 7 wherein the recipient system records electronic data relating to the payment intention to an IC card for authenticating the recipient, and deletes the electronic data relating to payment intention from the IC card either after the deposit account is sent or before the IC card is removed from the recipient system.

20. A system for mediating an electronic payment using a computer, comprising:
a payment intention registration/notification module receiving electronic data relating to a funds payment intention from a payer system belonging to a funds payer,
a deposit account registration processing module sending electronic data relating to the payment intention to a recipient system belonging to a funds recipient, receiving electronic data relating to deposit account identification from the recipient system, and registering the deposit account and information indicating that funds are unpaid in a payment status field in a database, and
a periodic processing module searching the database for a deposit account associated with the payment status indicating funds are unpaid and transferring funds from assets held by the payer to the deposit account.

21. The system of claim 20 wherein the periodic processing module changes the payment status to paid when funds have been transferred from the assets held by the payer to the deposit account.

22. The system of claim 20 wherein the periodic processing module changes the payment status to past due when funds no electronic data relating to the deposit account identification is received within the payment period or the payment due date.

23. A system for making an electronic payment using a computer, comprising:
a generation processing module generating electronic data relating to a payment intention containing a recipient ID for identifying a recipient and a payment amount and a payment period or a payment due date, and
a transmission processing module transmitting electronic data relating to the payment intention to a payment intermediary system, the payment intermediary system sending electronic data relating to the payment intention to a funds recipient when electronic data relating to the payment intention is received and depositing funds in the deposit account when a deposit account identification is received from the recipient within the payment period or the payment due date.

24. The system of claim 23 wherein the generation processing module begins processing according to a predetermined schedule or when an instruction to begin payment processing is received.

25. A computer-readable program for performing an electronic payment, comprising:
a payment intention creation process creating and sending electronic data relating to a funds payment intention,
a deposit account identification process creating electronic data relating to a recipient deposit account identification when electronic data relating to the payment intention is received, and
a periodic operation depositing funds to the deposit account when electronic data relating to the deposit account identification is received within a payment period or a payment due date contained in electronic data relating to the payment intention.

26. A network management system for mediating an electronic payment, comprising:
a payment intention arrival notification/transfer processing module receiving electronic data relating to a payment intention from an payment system by way of a network or broadcast signals, and sending electronic data relating to the payment intention by way of the network or the broadcast signals or a telephone network to a recipient terminal belonging to a recipient indicated by electronic data relating to the payment intention, the payment intention sending electronic data relating to the funds payment intention and depositing funds to a deposit account when data relating to a deposit account identification is received within a payment period or a payment due date indicated by electronic data relating to the payment intention, and
a deposit account identification processing module receiving electronic data relating to the deposit account identification from the mobile terminal by way of a network or a telephone network, and sending electronic data relating to the deposit account identification to the payment system by way of the network.

27. A system for depositing funds, comprising:
a storage device storing a public key for decrypting an electronic signature of a funds recipient, wherein:
the electronic signature is generated by using a secret key of the recipient to encrypt a payment intention issued by a funds payer each time a payment obligation is generated, the system further including:
a processing module receiving electronic data relating to deposit account identification, to which the electronic signature is attached,
a processing module determining if electronic data relating to the deposit account identification is received within a payment period or a payment due date indicated by electronic data relating to the payment intention,
a processing module decrypting the electronic signature using the public key, and
a processing module determining the legitimacy of a decrypted electronic signature based on electronic data relating to the payment intention.

28. A method for mediating an electronic payment using a computer wherein:
when electronic data relating to a funds payment intention is received from a funds payer, a financial institution system is queried regarding the existence of a recipient deposit account indicated by electronic data relating to the payment intention,
when electronic data relating to a payment intention containing identification of the deposit account is received each time a payment obligation is generated within a payment period or a payment due date indicated in electronic data relating to the payment intention, funds are transferred from assets held by the payer to the identified account.

29. A method for mediating an electronic payment using a computer wherein:
when electronic data relating to a funds payment intention is received from a funds payer, a financial institution system is queried to check for the existence of a recipient deposit account indicated in electronic data relating to the payment intention, and
when a response indicating the existence of the deposit account is received from the financial institution system, funds are transferred from assets held by the payer to the identified account.

30. A system for mediating an electronic payment using a computer, comprising:
a payment intention registration/notification processing module receiving electronic data relating to a funds payment intention from a payer system belonging to a funds payer,
a deposit account confirmation processing module receiving electronic data relating to the payment intention and sending electronic data to a financial institution system of a financial system to check that a recipient deposit account identified by electronic data relating to the payment intention exits,
a periodic processing module receiving electronic data indicating the existence of the deposit account from the financial institution system and transferring funds to the deposit account from assets held by the payer.

31. A method for mediating receipt of an electronic payment using a computer wherein:
a deposit account identification is received from a funds recipient,
data relating to the deposit account is stored in a database,
each time a payment obligation is generated, when the deposit account identification is received and a payment intention notification is received from a payer depositing funds in the deposit account or a payment intermediary, a deposit account for a recipient identified by the payment intention is retrieved from the database and the retrieved deposit account is notified to the payer or the payment intermediary.

32. A system for mediating receipt of an electronic payment using a computer, comprising:
a deposit account storage processing module storing data relating to a deposit account in a database, and
a deposit account identification processing module that, each time a payment obligation is generated, when the deposit account identification is received and a payment intention notification is received from a payer depositing funds in the deposit account or a payment intermediary, a deposit account for a recipient identified by the payment intention is retrieved from the database and the retrieved deposit account is notified to the payer or the payment intermediary.
